(19) United States
(12) Patent Application Publication
(10) Pub. No.: US 2026/0039740 A1
(43) Pub. Date: Feb. 5, 2026

(54) USING MOBILE DEVICE TO CREATE IMMERSIVE VEHICLE SESSIONS

(71) Applicant: VOLKSWAGEN AKTIENGESELLSCHAFT, Wolfsburg (DE)

(72) Inventors: Dominick AVIADO, Redwood City, CA (US); Fernando VITERI, Sunnyvale, CA (US); Vince TULIT, San Mateo, CA (US); Enes OLCAY, Redwood City, CA (US); Gerardo Alberto ROSSANO HERRERA, Saratoga, CA (US)

(21) Appl. No.: 18/980,821

(22) Filed: Dec. 13, 2024

Related U.S. Application Data
(60) Provisional application No. 63/678,704, filed on Aug. 2, 2024.

(51) Int. Cl. H04M 1/72409; G06F 3/0481

(52) U.S. Cl. CPC H04M 1/724098; G06F 3/0481

(57) ABSTRACT

A mobile application on a mobile device receives mobile acquired user data on the mobile device. The user data is specific for a user of a vehicle. Based on the user data, the mobile application selects vehicle session types for the user and communicates with vehicle built-in computing devices to cause GUI widgets corresponding to the vehicle session types to be rendered on an image display. Each GUI widget corresponds to a vehicle session type. In response to receiving an indication of a user selection of a specific GUI widget corresponding to a specific vehicle session type, the mobile application communicates with the vehicle built-in computing devices to cause a vehicle session of the specific vehicle session type to be played in the vehicle. Non-media vehicle components performs operations based on specific vehicle session configuration data specified by the mobile application for the specific vehicle session type.

### CROSS-REFERENCE TO RELATED APPLICATIONS

This application claims the benefit of priority to U.S. Provisional Patent Application No. 63/678,704, filed on Aug. 2, 2024, the contents of which are hereby incorporated by reference in their entirety.

### TECHNICAL FIELD

Embodiments relate generally to mobile devices and vehicles, and, more specifically, to using a mobile device to create immersive vehicle sessions.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In-vehicle batteries with larger capacities, vehicle built-in video and audio devices with better quality such as large high-resolution image displays and immersive audio systems, and vehicle components with more advanced functions and features have been more and more installed or incorporated in a wide variety of vehicles, especially in high-end models.

Under existing techniques, to a large extent, the potentials and capabilities of these devices, components, functions, and features, remain unexploited or under-utilized for many different reasons.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 illustrates an example vehicle session configuration and rendering system;

FIG. 2A illustrates an example external accessory server; FIG. 2B illustrates an example non-media vehicle component control gateway in communication with controllers of non-media vehicle components; FIG. 2C illustrates an example system architecture in which the vehicle session application implements mobile based vehicle infrastructure or component management functions; FIG. 2D illustrates an example UI framework;

FIG. 3A through FIG. 3K illustrate example graphic layouts for GUI display pages supporting playing, rendering and/or configuring vehicle sessions in a vehicle;

FIG. 4A through FIG. 4C illustrate example process flows; and

FIG. 5 is block diagram of a computer system upon which embodiments of the invention may be implemented.

### DETAILED DESCRIPTION OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. Structural Overview
   2.1. Mobile Device
   2.2. Vehicle Session Application
   2.3. External Accessory Server
   2.4. Vehicle Component Manager
   2.5. Non-Media Component Control
   2.6. User Interface and Media Rendering
   2.7. Session Media Rendering
   2.8. Miscellaneous
3.0. Functional Overview
   3.1. Vehicle Functions
   3.2. Vehicle Components
   3.3. UI Framework
   3.4. HMI Framework
   3.5. Home Screen
   3.6. Mood Configurations
   3.7. Session Rendering
   3.8. Health Data
   3.9. Media and Non-Media Configuration
   3.10. Additional GUI Examples
4.0. Example Process Flows
5.0. Implementation Mechanism-Hardware Overview
6.0. Extensions and Alternatives

### 1.0. GENERAL OVERVIEW

Under techniques as described herein, a vehicle equipped with media and non-media vehicle components may be controlled in a user friendly manner with a vehicle session application running on a mobile device to create, initiate, render or play a vehicle session. The vehicle session may be selected specifically for or by a user, from among a wide variety of different vehicle sessions through the vehicle session application on the mobile device. The vehicle built-in media components can be directed to render audio (e.g., audio only, etc.) or audiovisual content specifically configured for the vehicle session in the vehicle, whereas the non-media vehicle components of the vehicle can be directed to perform actions/operations specifically configured for the vehicle session to create an overall ambient environment within the vehicle as intended or specified for the vehicle session.

The vehicle session application deployed with or running on the mobile device can operate in the mobile device's mobile application operational environment or ecosystem to interact with the user through a mobile user interface (e.g., SIRI in an IOS environment, etc.), as well as to interact with first party or third party mobile applications including but not limited to mobile media applications and mobile health applications (e.g., Apple Health, Apple Fitness, etc.), first party or third party mobile supported/implemented APIs to interact with external data sources, etc., for the purpose of discovering, requesting or accessing mobile acquired or resident data and/or external data including but not limited to weather data, media data, vehicle session configuration data, user configuration data, user interaction data, etc., used or collected by the vehicle session application.

The vehicle session application running on the mobile device may implement several levels or categories of interactive graphic user interface (GUI) display pages. These GUI display pages or their visuals may be delivered to and rendered on an image display built in with the vehicle. The vehicle session application can send or provide some or all data or visuals/images relating to the GUI display pages to one or more computing systems built in or deployed with the vehicle such as a head unit through one or more data communication links between the mobile device and the computing systems or head unit of the vehicle. The data communication links between the mobile device and the computing systems of the vehicle may be established using APIs, protocols, code packages, libraries, tools and/or frameworks relating to one or more of: Apple External Accessory, Google Assistant for Vehicle, Android Auto, Volkswagen Infotainment Web Interface (VIWI), media streaming, audio or audiovisual streaming, HTTP, web servers, web sockets, RESTful web service points, markup languages, JSON, and so on. Example GUI display pages as described herein may include, but are not necessarily limited to only, any, some or all of: vehicle session application onboarding pages, “mood” display pages used to play specific vehicle sessions corresponding to different moods or user session types, “session” display pages used to configure media content or non-media vehicle components in specific vehicle sessions, etc.

The GUI display pages as implemented by the vehicle session application on the mobile device and rendered on the vehicle built-in image display allow the user (e.g., using tactile touches or gestures with the built-in image display or other non-visual controls such as physical buttons or wheels, etc.) to select or navigate vehicle sessions to be played, produced or experienced/consumed in the vehicle, to request or access health data collected by the mobile device and/or other external computing devices such as wearable devices, watches, etc., to configure vehicle sessions including configuring media contents for the vehicle sessions and/or configuring non-media vehicle components to perform specific operations/actions for the vehicle sessions. The GUI display pages implemented by the vehicle session application running on the mobile phone can be rendered on the vehicle built-in image display.

In-vehicle raw user interaction data (e.g., raw sensor data, touch events, on image display touch coordinates/positions, etc.) generated with interactions between the user and the in-vehicle user interfaces including but not limited to the built-in image display can be collected by the vehicle session application by way of the computing systems or head unit built in with the vehicle to generate (e.g. processed, application level, etc.) user interaction data. The user interaction data may then be used to select or navigate between or among different GUI display pages, access or activate UI controls (and/or GUI widgets, gadgets, tabs, popups, menus, etc.) provided with the GUI display pages, manipulate or set (e.g., create, retrieve, update, delete, etc.) vehicle session configuration data, etc. The vehicle session configuration data as described herein may include media configuration data that specifies specific media contents for the vehicle sessions as well as non-media configuration data that is used to set or control vehicle climate, ambient or contour lights, seat functions (e.g., seat massage functions, seat heating/ventilation functions, seat (e.g., positional, directional, etc.) adjustments, etc.), etc.

The vehicle session configuration data for a given vehicle session or type thereof may include timing or timer information. For example, a session duration may be set for a vehicle session or type thereof in the timing or timer information for the vehicle session. A session timer as described herein may be specified in the vehicle session configuration data such that the timer may fire a single time and, upon firing, automatically terminates an ongoing session. Additionally, optionally or alternatively, a session timer as described herein may be repeated until the user manually terminates an ongoing session. Additionally, optionally or alternatively, during the playing of a vehicle session, the user may manually terminate the session using a UI control rendered for session playing on a vehicle built-in image display as described herein.

Techniques as described herein can be implemented to support creating, rendering or playing a wide variety of vehicle sessions in a vehicle or in various types of vehicles. For example, a vehicle as described herein may be controlled with a mobile device to create or play a first vehicle session occurring (e.g., immediately, within a relatively short period of time of a few minutes, etc.) after the user has previously engaged in running activities outside of the vehicle. Likewise, the vehicle may be controlled with the mobile device to create or play a second vehicle session occurring (e.g., immediately, within a relatively short period of time of a few minutes, etc.) after the user has previously engaged in walking activities outside of the vehicle. The vehicle may further be controlled with the mobile device to create or play a cool vehicle session when the temperature outside the vehicle is relatively high. Similarly, the vehicle may be controlled with the mobile device to create or play a (relatively warm) fireside vehicle session when the temperature outside the vehicle is relatively low.

For a given vehicle session or a type thereof, the vehicle may be controlled with the mobile device to create, render or play a media content (or program) specifically configured for the vehicle session or type. For example, the media content such as a music piece may be selected by the user and streamed by the mobile device to the vehicle or the head unit (or vehicle built-in infotainment/entertainment system including but not limited to Volkswagen MIB3 commercially available from Volkswagen AG) therein. While the music piece is being rendered with a vehicle built-in (e.g., immersive, etc.) audio system in the vehicle, the vehicle may be concurrently controlled by the mobile phone to automatically (e.g., with no or little user input or manual action, etc.) operate or control one or more non-media vehicle components such as a vehicle built-in temperature controller, a vehicle built-in lighting controller, a vehicle built-in seat controller, a vehicle built-in air flow controller, actuators, etc., to perform specific vehicle component actions or operations adaptively for different portions of the music piece.

In some operational scenarios, after the user has engaged in or perform health and/or recreation related activities outside of the vehicle as tracked or monitored with the mobile device, the vehicle may be controlled with the mobile device to create or provide corresponding unique and versatile in-vehicle physical environments with specifically selected vehicle sessions that are complementary to the user's (prior) activities. As a result, the user's wellness and experience in connection with the user's prior activities can be further promoted or enhanced using the vehicle as a tool to create or provide complementary physical environments for or after these activities.

A vehicle session as controlled with the mobile device and implemented with the vehicle may be initiated or started at the same time or immediately (e.g., within a relatively short time such as a few seconds, within a minute, etc.) after the mobile device establishes wired or wireless data communication channels/connection with the vehicle and/or after the user enters the vehicle and/or in response to determining that the user has initiated, triggered or started the vehicle session.

In some operational scenarios, the user may operate or interact with the mobile device and the vehicle to direct or configure the vehicle to execute an initial phase (e.g., cooling down, warming up, etc.) of a vehicle session before the user enters the vehicle. In some operational scenarios, some or all temporal portions of a vehicle session may be implemented or activated while the vehicle is in a parked state. Additionally, optionally or alternatively, in some operational scenarios, at least a temporal portion of a vehicle session may be implemented or activated while the vehicle is being driven or propelled.

Media and non-media vehicle (e.g., software, hardware, mechanical, electrical, optical, electromechanical, electrooptical, etc.) components-such as head units (or entertainment/infotainment systems), audio systems, image displays, seats, windows, doors, lighting components, air conditioners, air ventilators, vehicle component controllers, vehicle operation controllers, etc.—in the vehicle may be used as vehicle session resources to precondition, control or activate the vehicle in accordance with vehicle session configuration data set forth for a vehicle session as described herein. Some or all of these in-vehicle or vehicle built-in components or resources may be used to implement vehicle sessions while (or under constraints/restrictions that) the user is inside the vehicle but the vehicle is (e.g., stationary, immobile, etc.) not being used for driving.

Operations or actions of media or non-media vehicle components may be integrated, coordinated, or synchronized to implement some or all of the vehicle sessions to provide relatively rich, immersive (e.g., using multi-audio-speaker audio panning, etc.) media (e.g., audio, visual, audiovisual, tactile, sensory, etc.) experiences.

In some operational scenarios, vehicle component (control or configuration) data or metadata may be generated or included along with media content or media content data to be streamed from the mobile device to the vehicle to enable the vehicle or the media and/or non-media vehicle components therein to effectuate, control and synchronize specific operations or actions of specific vehicle components.

Approaches, techniques, and mechanisms are disclosed for configuring and playing vehicle sessions in vehicles with mobile devices. According to one embodiment, a mobile application on a mobile device receives mobile acquired user data on the mobile device. The mobile acquired user data is specific for a user of the mobile device and a vehicle that connects with the mobile device. Based at least in part on the mobile acquired user data, the mobile application selects a set of vehicle session types for the user. The mobile application communicates with one or more vehicle built-in computing devices of the vehicle to cause a set of graphic user interface (GUI) widgets corresponding to the set of vehicle session types to be rendered on an image display of the vehicle. Each GUI widget in the set of GUI widgets corresponds to a respective vehicle session type in the set of vehicle session types. In response to receiving an indication of a user selection of a specific GUI widget corresponding to a specific vehicle session type, the mobile application communicates with the one or more vehicle built-in computing devices to cause a vehicle session of the specific vehicle session type to be played in the vehicle. One or more non-media vehicle components of the vehicle performs operations based at least in part on specific vehicle session configuration data specified by the mobile application for the specific vehicle session type.

In other aspects, the invention encompasses computer apparatuses and computer-readable media configured to carry out the foregoing techniques.

### 2.0. Structural Overview

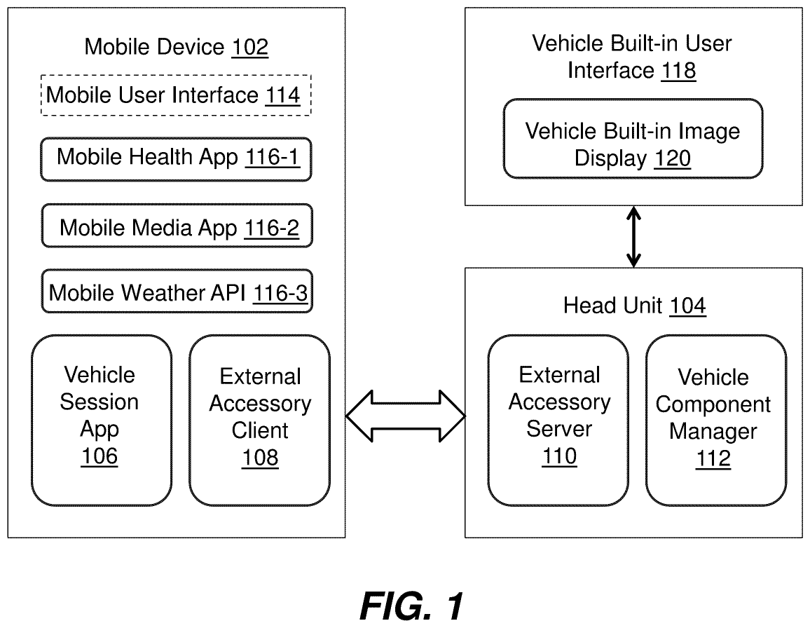

FIG. 1 illustrates an example vehicle session (configuration and rendering) system 100, in which vehicle session creation or generation techniques as described herein may be implemented or practiced, according to an embodiment. The vehicle session system 100 may be implemented with one or more computing devices comprising any combination of hardware and software configured to implement the various logical components described herein.

In some operational scenarios, the vehicle session system 100 includes a vehicle session application 106 (also referred to as “app” or “mobile app”), an external accessory client 108, one or more mobile applications such as a health application 116-1 and a media application 116-2, a mobile user interface 114, deployed with a mobile device 102, and/or one or more mobile implemented/supported APIs such as weather APIs 116-3; an external accessory server 110 and a vehicle component manager 112 deployed with a head unit 104 (also referred to as “entertainment/infotainment system”) built-in with a vehicle; a vehicle build—in user interface 118 deployed with the vehicle; etc.

The mobile user interface 114 of the mobile device 102 may be implemented with a mobile image display or other user interface elements such as buttons or touch user controls for non-visual user and/or system request, commands and/or responses, voice activation or SIRI based user controls, audio systems, microphones, etc.

The vehicle built-in user interface 118 may operate in conjunction with the head unit 104 and may be implemented with a relatively large relatively high resolution vehicle built-in image display 120, or other user interface elements such as vehicle built-m buttons or touch controls for non-visual user and/or system commands/responses, voice activation components, audio systems, microphones, etc.

The vehicle session system 100 may include one or more memories storing instructions for implementing various components described herein, one or more hardware or computing processors configured to execute the instructions stored in the one or more memories, and various data repositories in the one or more memories for storing data structures utilized and manipulated by various components in the vehicle session system 100.

### 2.1. Mobile Device

The mobile device 102 may be operatively connected with the head unit 104 of the vehicle through an in-vehicle wired data communication interface such as a USB connector or port built in with the vehicle and/or through one or more wireless data communication interfaces such as over Wi-Fi and/or Bluetooth supported by the vehicle or the head unit 104.

The wired or wireless data communication link(s) or connection(s) or transport(s) may be established between the mobile device 102 (or the external accessory client 108 therein) and the vehicle by way of the head unit 104 or the external accessory server 110 therein using one or more wired or wireless data communication protocols and/or mobile-vehicle APIs. Example data communication protocols and/or mobile-vehicle APIs may include, but are not necessarily limited to only, those related to one or more of: USB, Wi-Fi, Bluetooth, an TCP/IP protocol stack, a UDP/IP protocol stack, HTTP, web sockets, Apple CarPlay, Android Auto, iPhone/iPad/iPod Accessory Protocol or iAP2, Android Auto Projection or AAP, Google Assistant driving mode, VIWI, etc.

A mobile application (operating) environment or ecosystem may be provided on the mobile device 102 to allow mobile applications on the mobile device 102 to communicate with one another. The mobile environment or ecosystem (e.g., Apple ecosystem, Android ecosystem, etc.) may also include or provide APIs to allow a mobile application on the mobile device 102 to communicate with external data sources and/or external computing devices.

In an example, a media application such as an audio streaming application (e.g., Spotify, Apple Music, etc.) in the mobile ecosystem of the mobile device 102 may discover, request, access or stream external media contents through media APIs from media content providers to the mobile device 102.

In another example, the vehicle session application 106 may request, access or receive external realtime or non-realtime weather related data from a weather data provider through the weather APIs 116-3. In yet another example, the external accessory client 108 of the mobile device 102 may communicate (e.g., stream media contents, send GUI display pages for rendering on the vehicle built-in image display 120, receive raw or vehicle-collected user interaction data, etc.) with the external accessory server 110 of the head unit 104 of the vehicle through external accessory protocols or mobile-vehicle APIs.

Example media contents or programs may include, but are not necessarily limited to only, any, some or all of: contents or programs from public media content sources, contents or programs from proprietary or exclusive media content sources, immersive or non-immersive media contents provided by the vehicle's manufacturer, immersive or non-immersive media contents specific to the vehicle's model, etc.

### 2.2. Vehicle Session Application

The vehicle session mobile application or app 106 may be preinstalled, installed, or downloaded to the mobile device 102 from an application store, as a mobile app deployed or running on the mobile device 102. The vehicle session app 106 may include, operate or interact with the external accessory client 108 to establish the wired or wireless data communication link(s) or connection(s) or transport(s) between the mobile device 102 and the vehicle by way of the external accessory server 110 of the head unit 104.

The vehicle session application 106 may be specifically developed, implemented, initialized, and/or set up (e.g., Apple CarPlay entitlement, Apple CarPlay protocol string(s), Google Assistant code packages and/or files, etc.) for a vehicle as described herein in system design or engineering, or in onboarding operations such as performed with on boarding GUI display pages (e.g., rendered on the mobile device, rendered on an in-vehicle image display, etc.).

In some operational scenarios, the vehicle session app 106 operates or interacts with the external accessory client 108 to invoke APIs to generate HTTP messages (or RESTful messages) that specify the set or subset of vehicle session types. These HTTP messages may be encapsulated or communicated to the head unit 104 and received by API service interfaces or RESTful service interfaces implemented by the external accessory server 110 of the head unit 104. In response, the head unit 104 presents or renders . . . to the user on an image display such as the vehicle built-in image display 120.

The vehicle session app 106 can operate or interact with other mobile applications deployed or running (e.g., as a part of Apple IOS ecosystem, as a part of Android ecosystem, including both first and third party applications, etc.) on the mobile device 102 to collect other information maintained or collected by these other mobile applications as well as external data sources-external to the mobile device 102—through application programming interfaces (APIs) supported or implemented by the mobile device 102.

For example, the vehicle session app 166 may operate or interact with a mobile health app 116-1 on the mobile device 102—e.g., an Apple Watch app on an iPhone, etc.—to collect user (e.g., workouts, Breathe and Reflect sessions, running, walking, treadmill, gym activities, tennis, basketball, physical, exercise, leisure, heart rates, calories consumed, etc.) activity data that are automatically or manually provided, authorized or activated by the user. The user activity data may in part or in whole represent mobile acquired or resident user data collected (e.g., from the user's Apple Watch, etc.) by the mobile device 102 or the mobile health app 116-1 and may be used by the vehicle session app 166 as a basis to determine or generate a set or subset of vehicle sessions types specifically selected for the user from among a plurality of (e.g., candidate, all supported, all configured, etc.) vehicle session types. Additionally, optionally or alternatively, some or all of the mobile acquired/resident user data collected or received by the vehicle session app 106 may be used to rank or order individual vehicle session types in the set or subset of vehicle session types.

The vehicle session app 166 may also operate or interact with external data source(s) to collect or gather realtime or non-realtime external data through APIs supported or implemented (e.g., as a part of Apple IOS ecosystem, as a part of Android ecosystem, including both first and third party APIs, etc.) by the mobile device 102.

For example, the vehicle session app 166 may operate or interact with an external weather data source to collect or gather realtime and/or future weather data for a location at which the vehicle is located, through weather APIs 116-3. The weather data may in part or in whole used by the vehicle session app 166 as a basis to determine or generate the set or subset of vehicle sessions types specifically selected for the user from among the plurality of (e.g., candidate, all supported, all configured, etc.) vehicle session types. Additionally, optionally or alternatively, some or all of the external data (to mobile) such as the weather data collected or received by the vehicle session app 106 may be used to rank or order individual vehicle session types in the set or subset of vehicle session types.

The vehicle session app 166 may operate or interact with the mobile user interface 114 including but not limited to SIRI based user interface functions and/or the vehicle built-in user interface 118 to collect or gather realtime or non-realtime user (interaction) data generated based on the user interacting with these interfaces. The user data may in part or in whole used by the vehicle session app 166 as a basis to determine or generate the set or subset of vehicle sessions types specifically selected for the user from among the plurality of (e.g., candidate, all supported, all configured, etc.) vehicle session types. Additionally, optionally or alternatively, some or all of the user data collected or received by the vehicle session app 106 may be used to rank or order individual vehicle session types in the set or subset of vehicle session types.

The vehicle session app 104 may operate or interact with the head unit 104 of the vehicle by way of the external accessory client 108 to visually present the set of (selected) vehicle session types as UI controls (and/or GUI widgets, gadgets, tabs, popups, menus, etc.) on the vehicle built-in image display 120. For example, an image or video may be sent by the vehicle session app 104 to the head unit 104 to be rendered or displayed on the vehicle built-in image display 120.

The user may operate or interact with the vehicle built-in image display 120 through UI controls (e.g., touch sensors, etc.) to generate user input (or interaction) data, which may be collected and/or forwarded to the mobile device 102 or the vehicle session app 106 by the head unit 104.

Based on user input data collected by and received from the head unit 104 of the vehicle, the vehicle session app 104 determines or identifies a specific vehicle session type among the set of vehicle session types.

The vehicle session app 166 maintains vehicle session configuration data for all vehicle session types. The specific vehicle session type may correspond to a specific portion among the vehicle session configuration data maintained by the vehicle session app 166.

The vehicle session app 104 uses the specific vehicle session configuration data corresponding to the specific vehicle session type as selected by the user to initiate or start a vehicle session of the specific vehicle session type in the vehicle for the user.

The vehicle session app 104 may use non-media vehicle component control data or metadata as specified in the specific vehicle configuration data portion to generate and send non-media vehicle component operation/action requests to the head unit 104. These requests identify or specify specific non-media vehicle component operations/actions to be performed, for the vehicle session of the specific vehicle session type, by one or more non-media vehicle components in the vehicle.

Additionally, optionally or alternatively, the vehicle session app 166 may operate or interact with a mobile media app 116—2—e.g., a media streaming app, audio streaming app, Spotify, Music app, mobile video streaming app, etc.—deployed or running on the mobile device 102 to select a specific audio or audiovisual media content (or program) or portions thereof for the vehicle session of the specific vehicle session type for rendering by the vehicle or media vehicle components such as audio system, image display, audio or audiovisual codecs, audio speakers, etc. The specific audio or audiovisual media content may be selected based on the specific vehicle session configuration data portion. The vehicle session app 166 may operate or interact with the mobile media app 116-2 to stream, or cause to stream, the specific audio or audiovisual media content to the head unit 104 of the vehicle for playing or rendering with the media vehicle components in the vehicle.

Some or all of the vehicle session configuration data may be generated or created based at least in part on user interaction data. For example, the vehicle session app 106 may collect user input generated from the user interacting with the user controls or through other user interface elements presented on the mobile user interface 114 and/or the vehicle built-in user interface 118 including but not limited to the vehicle built-in image display 126 or other vehicle built-in user interface elements such as knobs, buttons, wheels, etc. Based on the user input, the vehicle session app 106 can set operational values for operational parameters specified in the vehicle session configuration data for the specific vehicle session type or any other vehicle session type supported by the vehicle session app 106. These operational values for the operational parameters corresponding to the specific vehicle session type may be used by the vehicle session app 106 to generate or create vehicle component action/operation requests/commands, for example in the form of requests/messages such as HTTP messages directed to RESTful service endpoints of a web server implemented by the head unit 104. These requests/commands may be used by the vehicle session app 106 to cause the corresponding vehicle component actions or operations to be performed by specific vehicle components for the vehicle session of the specific vehicle session type.

### 2.3. External Accessory Server

As illustrated in FIG. 1, the head unit 104 of the vehicle or the external accessory server 110 therein may be operatively connected with the mobile device 102 or the external accessory client 108 therein through one or more wired and/or wireless data communication interfaces such as over USB, Wi-Fi, Bluetooth, and so on.

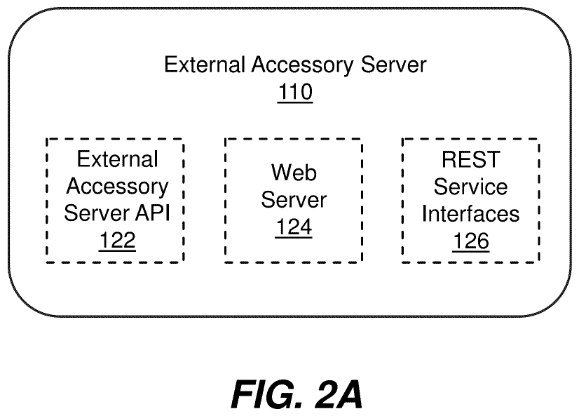

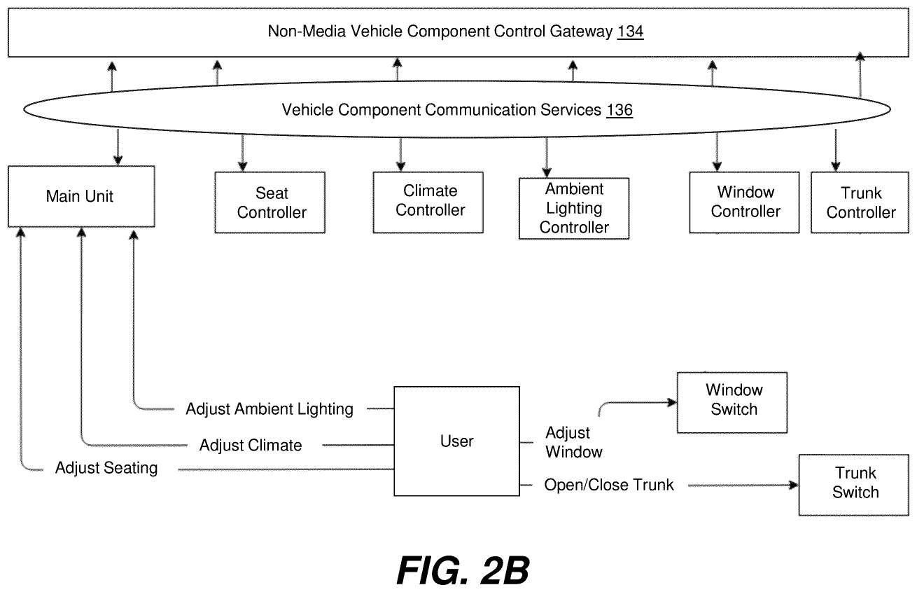

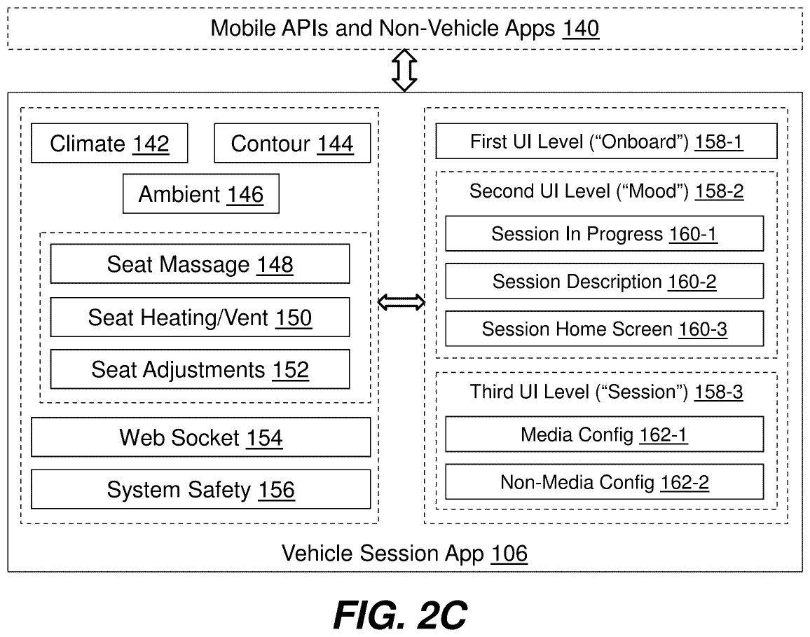

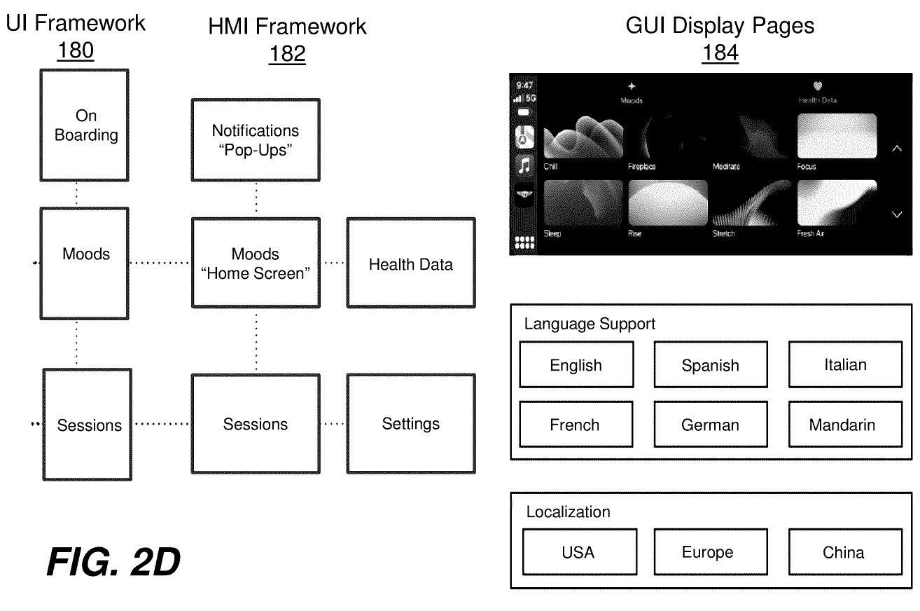

FIG. 2A illustrates an example external accessory server 110. As shown, the external accessory server 110 in the head unit 104 may implement external accessory protocols and/or mobile-vehicle APIs 122 in accordance with one or more mobile-vehicle communication interface specifications or standards. Example mobile-vehicle communication interface specifications or standards or APIs may relate to one of: Apple CarPlay, Android Auto, Google Assistant, etc. The external accessory protocols and/or APIs 122 may be used by the external accessory server 110 to communicate with the external accessory client 108 of the mobile device 102 to receive and/or process vehicle session related messages, requests, commands, etc., and to send back corresponding vehicle session related messages, statuses, responses, success or error indication messages, etc.

In some operational scenarios, the external accessory server 110 may include, implement or operate in conjunction with a vehicle based web server 124 that supports one or more web-based communication protocols and/or APIs. The vehicle based web server 124 may implement HTTP web service protocols and/or interfaces or RESTful (web) service protocols and/or interfaces 126 to receive HTTP messages or RESTful messages from the mobile device 102 or a mobile application therein to the (vehicle based) web server 124. These HTTP or RESTful messages may be processed by program logic implementing the HTTP or RESTful service interfaces 126 implemented with the web server 124.

Operational commands for vehicle component operations/actions may be generated by the program logic implementing the HTTP or RESTful service interfaces 126 based on the received HTTP messages or RESTful messages from the mobile device 102. These operational commands may be sent to the vehicle component manager 112 of FIG. 1 to carry out or perform the vehicle component operations/actions identified or specified with the operational commands.

Corresponding responses to the operational commands for the vehicle component operations/actions may be received by the program logic implementing the HTTP or RESTful service interfaces 126 from the vehicle component manager 112. HTTP responses/messages or RESTful responses/messages may be generated by the program logic implementing the HTTP or RESTful service interfaces 126 based on the received responses and sent to the mobile device 102 by way of the web server 124. Some or all of the HTTP responses/messages or RESTful responses/messages sent to the mobile device 102 may be formatted as JavaScript Object Notation (JSON) responses/messages. These HTTP responses/messages or RESTful responses/messages serve as vehicle session operational responses to the HTTP or RESTful requests/commands previously received from the mobile device 102.

### 2.4. Vehicle Component Manager

The head unit 104 of the vehicle or the external accessory server 110 therein may include, operate or interact with the vehicle component manager 112 to render media contents for specific vehicle session(s) with media components built in with the vehicle such as vehicle built-in audio or audiovisual codecs, vehicle-built-in audio speakers, or the vehicle built-in image display 120. The vehicle component manager 112 of the head unit 104 may further include, operate or interact with a non-media vehicle component control gateway 134 to control—or obtain operational states of—non-media vehicle components (e.g., climate control, lighting control, seat control, HVAC, etc.) for the specific vehicle session(s).

### 2.5. Non-Media Component Control

As illustrated in FIG. 2B, the non-media vehicle component control gateway 134 operating in conjunction with the external accessory server 110 may communicate with relatively low-level controllers or microcontrollers of non-media vehicle components via in-vehicle data communication links or paths such as ethernet, controller area network(s) or CAN(s), MQTT, etc., using applicable in-vehicle data communication protocols and/or APIs (e.g., in a shared library, based on messages such as markup language messages, etc.).

In some operational scenarios, the non-media vehicle component control gateway 134 of FIG. 2B may communicate with relatively low level (e.g., hardware, firmware, embedded system, etc.) controllers or microcontrollers of the vehicle components using one or more vehicle component communication services/networks 136 including but not necessarily limited to only a CAN bus (also referred to as “KCAN”). Commands, requests and/or responses may be exchanged between the vehicle component control gateway 134 and each of the vehicle components for the purpose of obtaining states of, and performing operations with, the vehicle components for playing the specific vehicle session(s). The vehicle components may include, but are not necessarily limited to only, a main unit operated by the user (e.g., the same as the user of the mobile device, the driver, a passenger, etc.) to adjust ambient lighting, climate and seating for the specific vehicle session(s); a seat controller, a climate controller, an ambient lighting controller, a window controller, a trunk controller, etc.

The vehicle component control gateway 134 may communicate or operate in conjunction with some or all of the relatively low level controllers for the vehicle components from performing some or all operations using these vehicle components.

### 2.6 User Interface and Media Rendering

The head unit 104 may operate or interact with the user via the vehicle built-in user interface 118. The vehicle built-in user interface 118 may include or operate with the vehicle built-in image display 120, which may be used to render GUI display page.

Some or all of the GUI display pages and/or image/video contents may be visually rendered on the vehicle built-in image display 120. Additionally, optionally or alternatively, GUI display page related controls/statuses and/or audio contents may be audibly rendered through the vehicle built-in audio system.

The vehicle built-in user interface 118 may also be used by the vehicle session app 106 of the mobile device 102 to interact with the user to obtain or generate user interaction data in connection with vehicle sessions. For example, the vehicle built-in image display 120 of the vehicle built-in user interface 118 may be touch sensitive or may be equipped with user gesture detection sensors to obtain or collect (raw) user interaction data based on user gestures or touches made with respect to the vehicle built-in image display 120. Additionally, optionally or alternatively, other non-visual user interface components or controls deployed or built-in with the vehicle may be used as a part of the vehicle built-in user interface 118 to obtain or collect (raw) user interaction data based on user actions made with respect to these non-visual user interface components or controls. Example user actions may include, but are not necessarily limited to only, any, some or all of: haptic touch operations, key entry operations, voice activated operations, national language processing implemented with machine learning, etc.

### 2.7. Session Media Rendering

The head unit 104 may include, operate or interact with a media renderer to play or render media contents for the specific vehicle session(s). The head unit 104 or the media renderer therein may implement a set of media framework APIs, which may include—but are not necessarily limited to only-media control APIs, audio streaming APIs, video/image streaming APIs, etc. The media control APIs may be used to control operations, operational states and/or operational modes of the vehicle built-in image display 120 and/or the audio system built in with the vehicle. The audio streaming APIs may be used to stream audio data and metadata to the audio system built in with the vehicle for rendering or sound production/reproduction purposes.

The video/image streaming APIs may be used to stream image/video data and metadata to the vehicle built-in image display 120 (or image codecs operating in conjunction therewith) built in with the vehicle for rending or displaying.

In some operational scenarios, the image(s) relating to the audio contents being played or selected or otherwise presented may be displayed or rendered, for example in one or more designated regions/portions of the overall vehicle built-in image display 120.

### 2.8. Miscellaneous

The system 100 illustrates only one of many possible arrangements of components configured to provide the functionality described herein. Other arrangements may include fewer, additional, or different components, and the division of work between the components may vary depending on the arrangement.

### 3.0. Functional Overview

In an embodiment, some or all techniques and/or methods described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### 3.1. Vehicle Functions

FIG. 2C illustrates an example system architecture in which the vehicle session application 106 of FIG. 1 operates with other mobile applications and/or mobile supported APIs and implements mobile based vehicle infrastructure or component management functions (or simply “vehicle functions”) and vehicle session related GUI display pages (or simply “GUI display pages”). These vehicle functions may be implemented in the vehicle session application 106 using mobile-vehicle APIs, protocols, tools, code libraries, etc., such as VIWI commercially available from Volkswagen AG.

The vehicle functions implemented in the vehicle session application 106 may include a first subset of vehicle (infrastructure) functions 156 related to system safety. The system safety vehicle functions 156 may be used to validate whether any (e.g., other) vehicle function invoked by the vehicle session application 106 involves a vehicle operation that is safe to be performed in the current operational state of the vehicle or vehicle components therein.

The vehicle functions implemented in the vehicle session application 106 may include a second set of vehicle (infrastructure) function 154 related to establishing or shutting down data communication links or channels-such as web socket(s) supported by VIWI-between the vehicle session application 106 or other mobile applications (e.g., streaming applications, etc.) of the mobile device 102 and the external accessory server 110 of the head unit 104 of the vehicle. The data communication links established by the web socket vehicle functions 154 may be used by the vehicle session application 106 to provide, send or transmit application level data or messages to the head unit 104 of the vehicle for rendering GUI display pages on the vehicle built-in image display 118. The data communication links may be used by the vehicle session application 106 to provide, send or transmit application level data or messages to the head unit 104 of the vehicle for managing operational states of—or performing operations by—specific vehicle components of the vehicle. The data communication links may be used by the vehicle session application 106 to direct or redirect media data or media stream from mobile media applications to the head unit 104 of the vehicle for rendering with the vehicle built-in media or audio system of the vehicle.

### 3.2. Vehicle Components

The vehicle functions implemented in the vehicle session application 106 may include a third subset of vehicle (component management) functions 148, 150 and/or 152 related to non-media vehicle components of the vehicle such as vehicle seat(s). The seat vehicle functions 148, 150 and/or 152 may be used to manage/control operational states—or perform operations by—one or more seats of the vehicle for specific vehicle sessions to be played or rendered for the user to experience. For example, these seat vehicle functions 148, 150 and/or 152 may manage/control—e.g., seat massage, seat heating/ventilation, seat positional or directional adjustment, etc.—functions or settings of the seats of the vehicle for the specific vehicle sessions.

The vehicle functions implemented in the vehicle session application 106 may include a fourth subset of vehicle (component management) functions 142, 144 and/or 146 related to other non-media vehicle components such as climate (or environment), contour lighting, ambient lighting, etc., inside the vehicle. These non-seat vehicle functions 142, 144 and/or 146 may be used to manage/control operational states—or perform operations by—ventilator, air flow control, air conditioner, contour lights, ambient lights, etc., of the vehicle as a part of the specific vehicle sessions to be played or rendered for the user to experience. These non-seat vehicle functions 142, 144 and/or 146 may manage/control—e.g., level or strength, color, intensity, etc.—operational states of the corresponding non-seat vehicle components of the vehicle for the specific vehicle sessions.

In some operational scenarios, non-media vehicle components in the vehicle—which may include, but not necessarily limited to only, any of those illustrated in FIG. 2B or FIG. 2C—may be used as a part of the specific vehicle sessions. Additionally, optionally or alternatively, non-vehicle vehicle component management operations as initiated or requested by the vehicle session application 106 and as carried out by non-media vehicle components of the vehicle may be synchronized (e.g., using control data or metadata provided by the vehicle session application 106 to the vehicle, etc.) with media or audio rendering in the vehicle for the specific vehicle sessions.

Mobile-originated requests, commands or messages for controlling or managing operational states of and/or for performing actions/operations by vehicle components may be received by the external accessory server 110 or the web server 124 therein (as shown in FIG. 2A) in the vehicle. Corresponding REST service interfaces or functions 126 may be invoked to process these mobile-originated requests, commands or messages, which may be forwarded, transformed and/or redirected to the vehicle component manager 112 of FIG. 1 to control or manage the operational states of and/or to cause the actions/operations to be performed by the vehicle components. Relatively low level requests, commands or messages may be sent by way of the non-media vehicle component control gateway 134 via in-vehicle data communication links or networks using communication protocols such as VIWI, KCAN, K2-CAN, Vector CancaseXL, USB data links, CANs, ethernets, MQTT, etc.

Some or all of the external accessory server 110 and/or vehicle component manager 112 of FIG. 1 may be developed, implemented, coded, compiled, and/or linked (e.g., with standard based or proprietary libraries for vehicle based computing application, Python libraries, etc.) into executables using one or more relatively high level computing languages including but not limited to Python, C, C++, etc.

### 3.3. UI Framework

FIG. 2D illustrates an example UI framework 180 implemented by the vehicle session application 106 installed or running on the mobile device 102. As illustrated, the UI framework 180 may comprise or include multiple levels or categories for GUI display pages 184.

In the UI framework 180, a first set of GUI display pages of a first UI framework level (158-1 of FIG. 2C) or denoted as “On Boarding” may be used by the user to perform initialization and/or application setup and/or training/tutorial operations (or application onboarding applications) relating to the vehicle session application 106.

In the UI framework 180, a second set of GUI display pages of a second UI framework level (158-2 of FIG. 2C) or denoted as “Moods” may be used by the user to access, play or render vehicle sessions of various different vehicle session types implemented or supported by the vehicle session application 106. Example GUI display pages of the second UI framework level 158-2 may include, but are not necessarily limited to only, “Session in Progress” display page (160-1 of FIG. 2C), “Session Description” display page (160-2 of FIG. 2C), “Home Screen” display page (160-3 of FIG. 2C), etc.

Some or all of the GUI display pages of the second UI framework level 158-2 may utilize or may be generated based at least in part on input received from or interactions with other mobile applications such as mobile media or audio applications, mobile media or audio content streaming applications, mobile user assistance applications (e.g., SIRI, Cortana, Google Assistant, etc.), mobile supported APIs such as weather APIs, etc.

In the UI framework 180, a third set of GUI display pages of a third UI framework level (158-3 of FIG. 2C) or denoted as “Sessions” may be used by the user to access and configure (vehicle sessions of) various different vehicle session types implemented or supported by the vehicle session application 106. Example GUI display pages of the third level 158-3 may include, but are not necessarily limited to only, media configuring display pages 162-1 selecting and/or configuring and/or accessing specific media or audio content sources/applications/servers to be accessed by the vehicle session application 106 for specific vehicle sessions; media configuring display pages 162-1 selecting and/or accessing specific media or audio contents to be selected, accessed, streamed from media or audio content sources/applications/servers to the vehicle by the vehicle session application 106 for specific vehicle sessions; non-media configuring display pages 162-2 selecting and/or configuring operational states of specific non-media vehicle components of the vehicle by the vehicle session application 106 for specific vehicle sessions; non-media configuring display pages 162-2 selecting and/or requesting and/or triggering performance of operations/actions of specific non-media vehicle components of the vehicle by the vehicle session application 106 for specific vehicle sessions; etc.

Some or all of the GUI display pages of the third UI framework level 158-3 may utilize or may be generated based at least in part on interactions with non-media vehicle (component management) functions 142, 144 and/or 146 relating to climate, contour lighting, ambient lighting, etc.; vehicle (component management) functions 148, 150 and/or 152 relating to seat massage, seat heating/ventilation, seat adjustments, etc.; vehicle (infrastructure) function 154 relating to mobile-vehicle communication links or channels, system safety, etc.; and so on.

### 3.4. HMI Framework

As illustrated in FIG. 2D, the GUI display pages 184 in the UI framework 180 may be accessed, viewed, invoked, rendered, interacted with, or navigated using a human-machine interface (HMI) framework 182 as illustrated in FIG. 2D.

For example, a main GUI display page denoted as “Moods ‘Home Screen” in the second UI framework level (denoted as “Moods” in FIG. 2D; 158-2 of FIG. 2C) of the UI framework 180 may be used by the vehicle session application 106 to present to a (human) user a set of vehicle sessions for the user to view, select or access. From this “Home Screen” display page, the user can access/view or can be presented with additional real time and/or non-real time information and/or selectable options relating to any, some or all of the vehicle sessions and/or operations/states of non-media vehicle components and/or media or audio contents or streams using attendant display denoted as “Notifications ‘Pop-Ups” in panels/menus/sub-panels/popups. Additionally, optionally or alternatively, from the “Home Screen” display page, the user can access/view or can be presented with additional real time and/or non-real health data (e.g., collected by the mobile device 102, collected from a wearable device such as Apple Watch operating with the mobile device 102, etc.) using attendant display denoted as “Health Data” in panels/menus/sub-panels/popups.

The main GUI display page (“Moods ‘Home Screen’”) may be used by the user to navigate to session display pages in the third UI framework level (denoted as “Sessions” in FIG. 2D; 158-3 of FIG. 2C) of the UI framework 180. Media and/or non-media configuration data for some or all vehicle session types supported by the vehicle session application 106 may be viewed, selected, accessed or configured (e.g., create, retrieve, update, delete, etc.) by the user. For example, the session display pages may present or display currently configured data field values or settings for the media and/or non-media configuration data. The user can drill down or navigate to (e.g., summary, detail, vehicle session, etc.) setting display pages in the third UI framework level (denoted as “Settings” in FIG. 2D; 158-3 of FIG. 2C) of the UI framework 180. From the setting display page, the user can create, retrieve, update and/or delete some or all specific data field values or settings for the media and/or non-media configuration data for a specific vehicle session.

Some or all of these display pages 184 may be implemented with language support in a variety of different languages such as English, Spanish, Italian, French, German, Mandarin, etc. Additionally, optionally or alternatively, some or all of these display pages 184 may be localized or specifically adapted for different geographic locations or vehicle operational regions such as the U.S.A., Europe, China, etc.

### 3.5. Home Screen

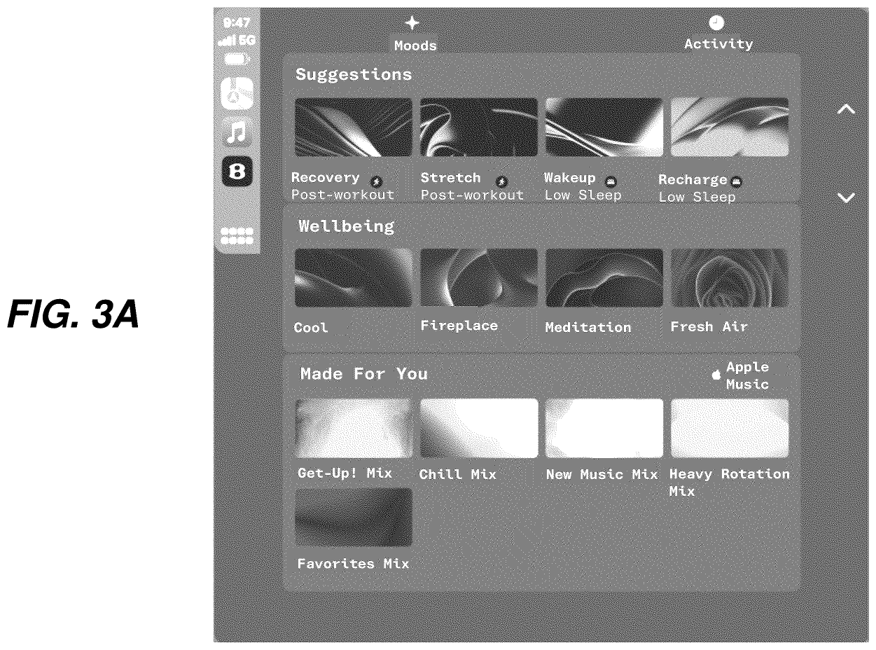

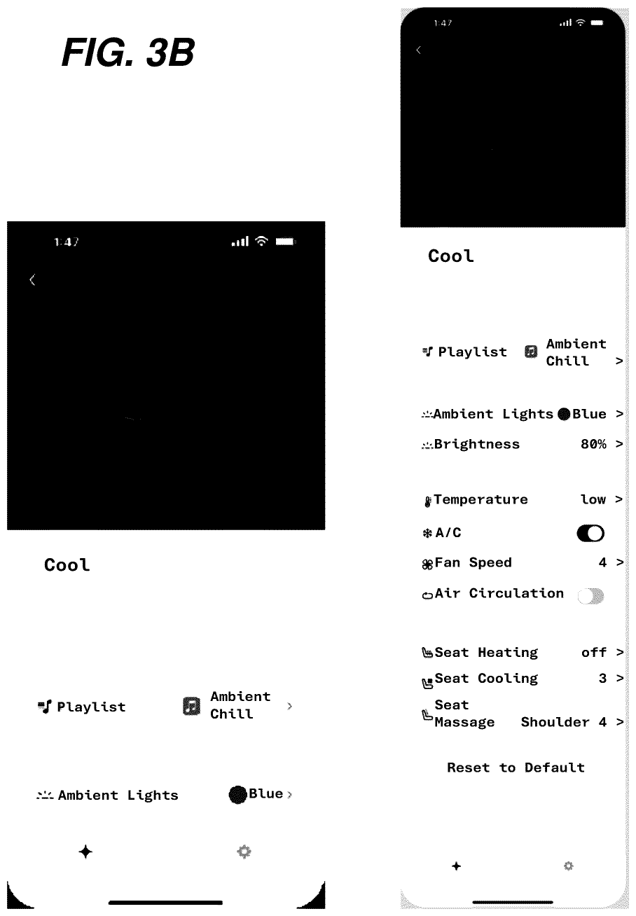

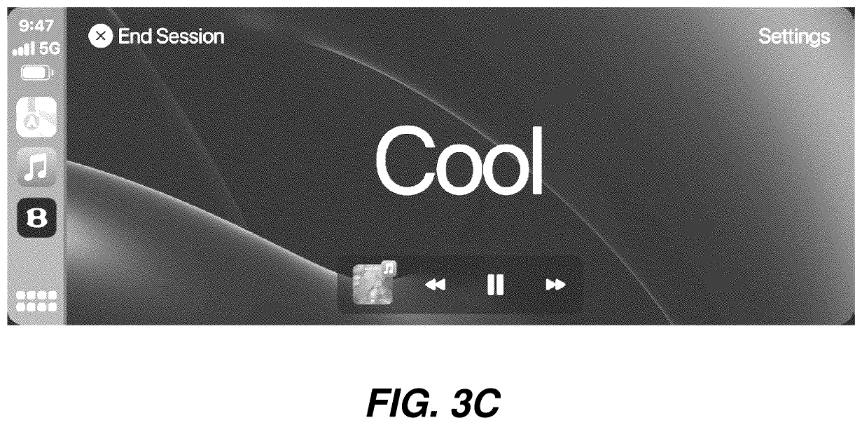

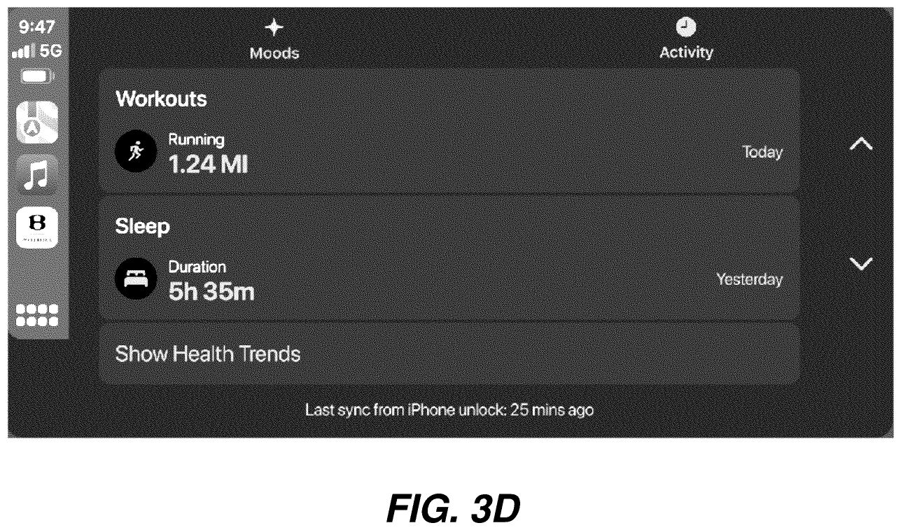

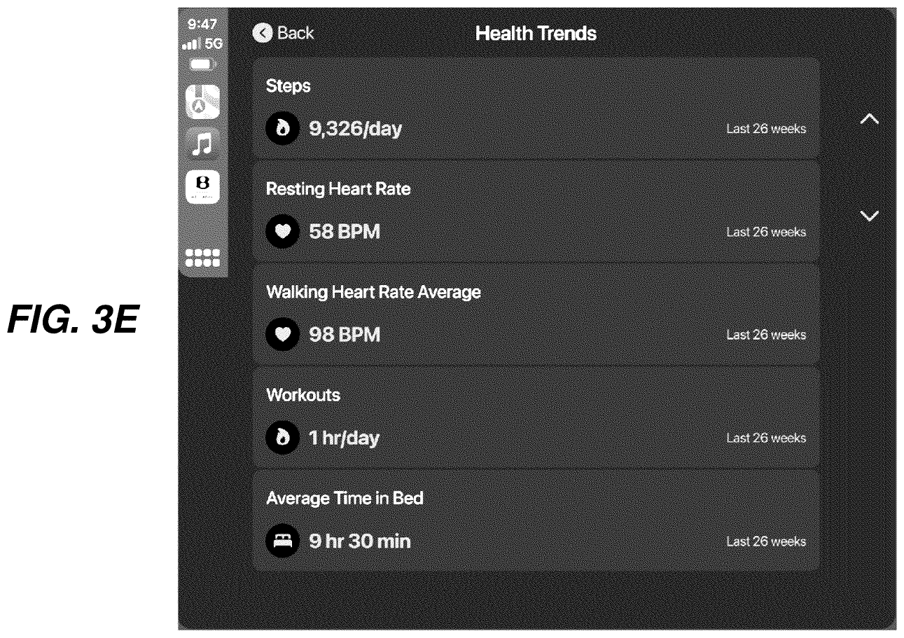

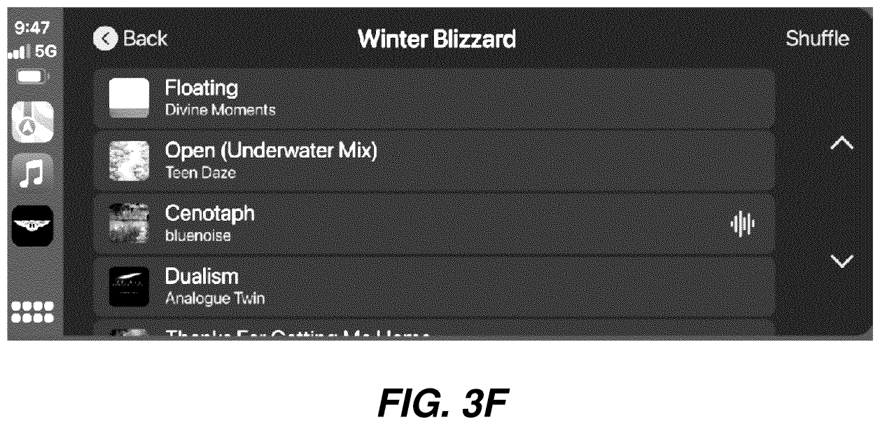

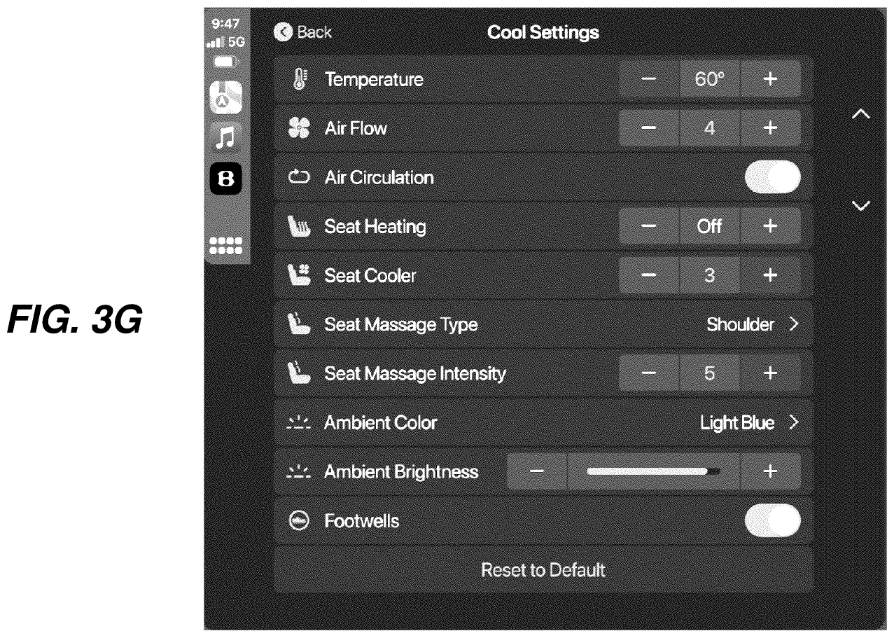

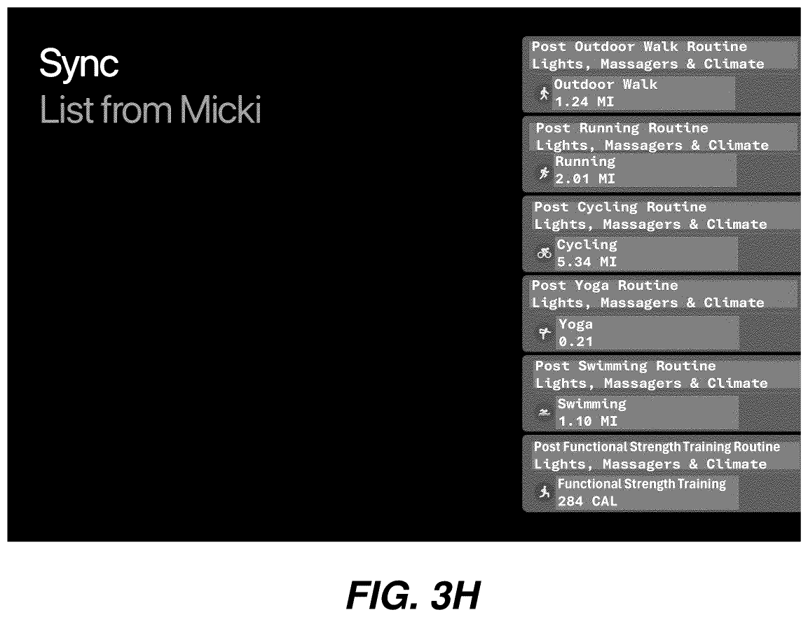

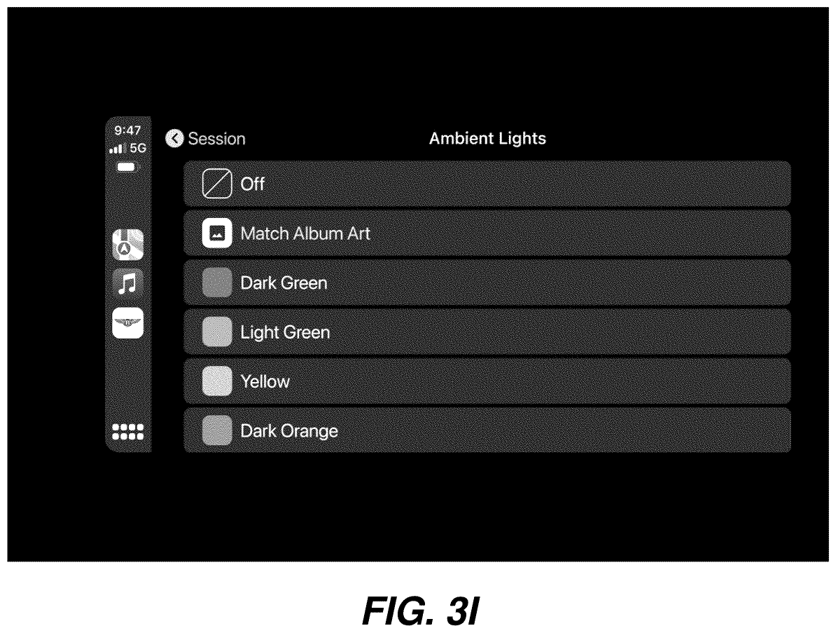

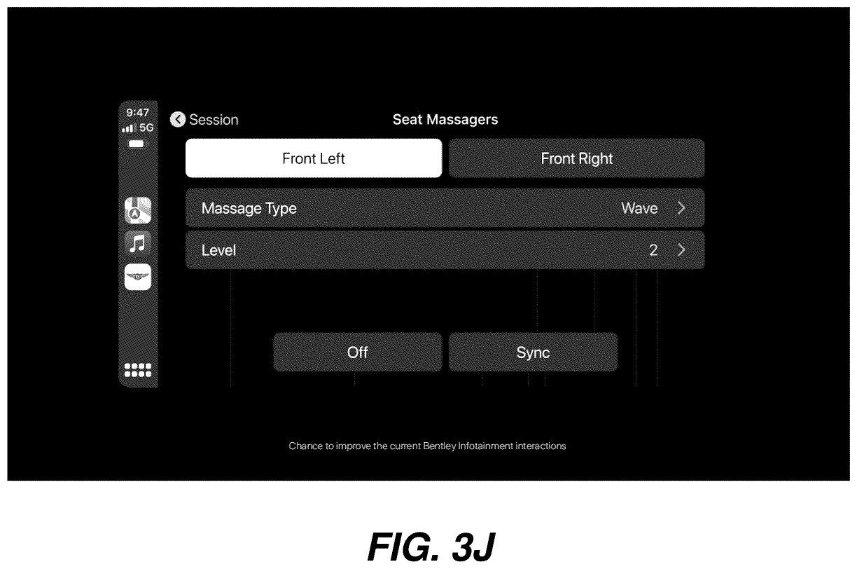

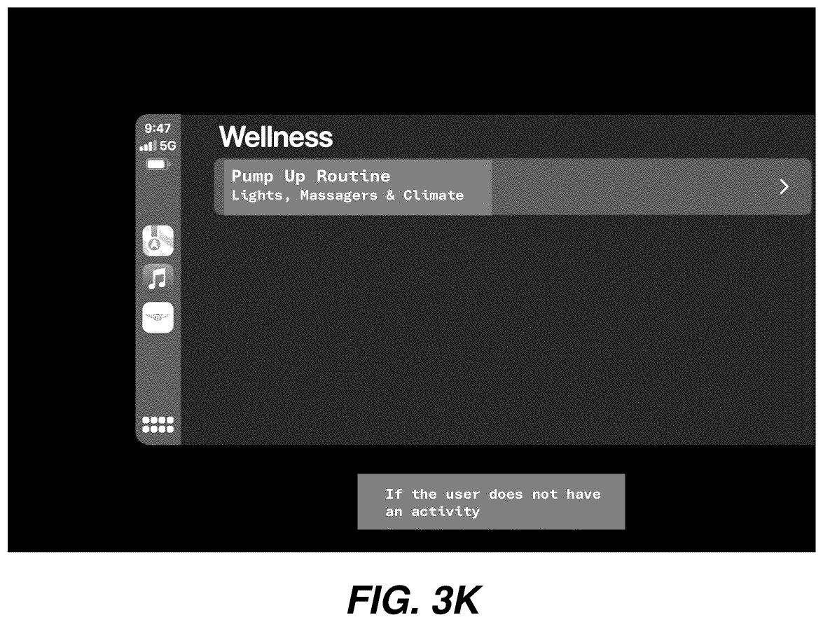

FIG. 3A through FIG. 3K illustrate example graphic layouts for GUI display pages for the vehicle session application 106 that supports playing, rendering and/or configuring vehicle sessions in the vehicle. Some or all of these display pages may present or display other UI or graphic components that support vehicle session related operations.

These GUI display pages may be caused by the vehicle session application 106 on the mobile device 102 to be displayed or rendered on the vehicle built-in image display 120 by way of the head unit 104 of the vehicle. Corresponding in-vehicle user input captured with respect to these display pages may be captured, collected and transmitted/or to the mobile device 102 or the vehicle session application 106.

In some operational scenarios, images depicting these GUI display pages may be generated or pre-generated by the vehicle session application 106 and transmitted, streamed, sent or provided to the head unit 104 for rendering or displaying on the vehicle built-in image display 120. In-vehicle user input (e.g., GUI based, non-GUI based, etc.) such as coordinates of user tactile and/or input operations/actions/gestures may be collected as a part of the in-vehicle user input and transmitted to the mobile device 102 or the vehicle session application 106.

FIG. 3A illustrates an example graphic layout for the “Home Screen” display page. As illustrated, different vehicle session types (or moods) may be grouped in three different groups.

The first group in the vehicle session types is associated with a first theme denoted as “Suggestions”. This first group may include suggestions or selections for vehicle session types (relating to different user activities) dynamically and/or adaptively generated for the user in part or in whole based on the user's realtime or non-realtime health and/or physical activity/inactivity data and/or the user's past selections and/or experiences of vehicle sessions or vehicle session types.

For example, in response to determining, based on the heath and activity related data collected from other mobile applications and/or APIs, that the user has just had a workout, a number of specific vehicle sessions such as “Recovery”, “Stretch”, etc., may be presented in the first group (“Suggestions”) on the “Home Screen” display page with relatively high importance or visibility. Additionally, optionally or alternatively, the user's past selections and/or experiences of vehicle sessions of specific vehicle session types may be maintained or stored by the vehicle session application 106 and used to identify, select, rank or present the vehicle session types of the first group.

The second group in the vehicle session types as presented or displayed with the “Home Screen” display page of FIG. 3A is associated with a second theme denoted as “Wellbeing”. This second group may include suggestions or selections for vehicle session types aimed at improving the user's wellbeing or user experience inside the vehicle.

For example, a number of specific vehicle session types such as “Cool”, “Fireplace”, “Meditation”, “Fresh Air,” etc., may be identified to correspond to different user moods or user preferences. These vehicle session types may be presented in the second group (“Wellbing”) on the “Home Screen” display page with relatively high importance or visibility. Hence, if the user happens to feel warm or hot, then the user can select or play a “Cool” vehicle session in the vehicle by way of selecting the corresponding UI control on this “Home Screen” page. On the other hand, if the user happens to feel chilly, then the user can select or play a “Fireplace” vehicle session in the vehicle by way of selecting the corresponding UI control on this “Home Screen” page. Similarly, the user can seek to improve the user's wellbeing by selecting a “Meditation” or “Fresh Air” vehicle session type to experience with the vehicle.

The third group in the vehicle session types as presented or displayed with the “Home Screen” display page of FIG. 3A is associated with a third theme denoted as “Made For You”. This third group may include vehicle session types relating to specific media or audio contents selected from media or audio sources/applications for the user. The user may select any of these media or audio contents for rendering, displaying or reproducing with in-vehicle media or audio system of the vehicle. In a vehicle session of a user selected vehicle session type, specific media or audio content configured or selected for the vehicle session may be rendered in the vehicle while one or more non-media vehicle components of the vehicle is in specific operational states configured or specified by configuration data of the selected vehicle session type. Additionally, optionally or alternatively, some or all of the non-media vehicle components may perform specific operations or actions configured or specified in the configuration data of the selected vehicle session type.

For example, a number of specific vehicle session types such as “Get up! Mix,” “Chill Mix,” “New Music Mix,” “Heavy Rotation Mix,” etc., may be identified to correspond to different media or audio contents from a mobile media application or source “Apple Music” may be included or presented in the third group (“Made For You”) on the “Home Screen” display page with relatively high importance or visibility. The user's past selections and/or experiences of media or audio contents from the mobile media application/source and/or corresponding vehicle sessions may be maintained or stored by the vehicle session application 106 and/or by the mobile media application/source and used to identify, select, rank or present the vehicle session types of the third group.

### 3.6. Mood Configurations

FIG. 3B illustrates example graphic layouts for two mood configuration display pages for a specific vehicle session type or mood. More specifically, some or all vehicle session (type) configured data for the specific vehicle session type—such as one corresponding to a “Cool” mood or a different mood—as configured or maintained by the vehicle session application 106 on the mobile device 102 may be displayed in a first (summary) GUI display page illustrated on the left of FIG. 3B or in a second (more detailed) GUI display page illustrated on the right of FIG. 3B.

By way of example but not limitation, the first GUI display page on the left of FIG. 2B may visually indicate or identify one or more media programs such as audio programs or music pieces configured for the specific vehicle session type, ambient light information such as light color, GUI controls to access related display pages such as the “Home Screen” display page or setting pages used to configure, view, create or update vehicle session (type) configuration data for the specific vehicle session type or a different type, etc.

In comparison, the more detailed mood configuration display page on the right side of FIG. 3B may include additional information or data fields, which may include but are not necessarily limited to only, any, some or all of: (e.g., ambient light, in percentile, etc.) brightness, temperature, air conditioning (A/C), fan speed, air circulation, seat heating, seat cooling, seat massage, etc. GUI controls such as “Reset to Defaults” may also be presented, for example to allow some or all the configured data of the specific vehicle session type to revert to or to be configured with default values.

In some operational scenarios, one or both of the GUI display pages of FIG. 3B may be implemented as notification display pages selectable or accessible from the “Home Screen” display page as illustrated in FIG. 3A or a vehicle session (type or mood) playing in progress GUI display page of FIG. 3C, for example as pop-up(s) when the user highlights or selects—for example, corresponding menu option(s) for—the vehicle session type (or mood).

### 3.7. Session Rendering

FIG. 3C illustrates an example graphic layout for vehicle session playing in progress display page. This display page may be accessed from the “Home Screen” display page or another display page to play or render a vehicle session of a specific vehicle session type or mood-such as one corresponding to the “Cool” mood or the like—with media and/or non-media vehicle components in a vehicle as described herein. A number of GUI controls such as “Pause”, “Play” “Fast Forward”, “Rewind”, “End Session,” etc., may be accessible on the vehicle built-in image display 120 by the user to control operations of playing or rendering the vehicle session. Additionally, optionally or alternatively, settings of the specific vehicle session type or mood to which the vehicle session belongs may be selected, viewed, configured or re-configured.

### 3.8. Health Data

FIG. 3D illustrates an example graphic layout for a first health related data display page. This display page may be accessed from the “Home Screen” display page, a vehicle session playing display page, a different health related data display page, or a different display page rendered on the vehicle built-in image display 120. Data relating to the user's physical or resting activities (e.g., workouts, running, walking, resting, sleeping, meditation, breathe exercise, duration, timing information, etc.) can be collected and/or processed by the vehicle session application 106 from other mobile application(s) in the ecosystem of the mobile device 102. Additionally, optionally or alternatively, some or all of the data may be collected and/or processed from accessory devices such as an Apple Watch or another wearable device pairing with the mobile device 102. Some or all of the collected data relating to the user's physical or resting activities can be displayed or rendered on this display page. Additional health related data relating to the user's physical or resting activities may be accessed with GUI controls such as scroll bars. Other display pages may be directly or indirectly accessed with specific GUI controls rendered and included on this first health related data display page.

FIG. 3E illustrates an example graphic layout for a second health related data display page. This display page may be accessed from the “Home Screen” display page, a vehicle session playing display page, a different health related data display page, or a different display page rendered on the vehicle built-in image display 120. Data relating to the user's health trends (e.g., steps completed, resting heart rate, working heart rate average, daily average workouts, average time in bed, etc.) can be collected and/or processed by the vehicle session application 106 from other mobile application(s) in the ecosystem of the mobile device 102. Additionally, optionally or alternatively, some or all of the data relating to the user's health trends may be collected and/or processed from accessory devices such as an Apple Watch or another wearable device pairing with the mobile device 102. Some or all of the collected data relating to the user's health trends can be displayed or rendered on this display page. Additional health related data relating to the user's health trends may be accessed with GUI controls such as scroll bars. Other display pages may be directly or indirectly accessed with specific GUI controls rendered and included on this first health related data display page.

3.9. MEDIA AND NON-MEDIA CONFIGURATION

FIG. 3F illustrates an example graphic layout for media configuration display page. This display page may be accessed from the “Home Screen” display page, a vehicle session playing display page, or a different display page rendered on the vehicle built-in image display 120. In some operational scenarios, a media program to be configured and/or rendered in a vehicle session by the vehicle built-in media components of the vehicle may be a single media or audio piece, or a combination or playlist of multiple media or audio pieces in a sequential or shuffle order. By way of illustration but not limitation, a playlist named “Winter Blizzard” may be configured or displayed in this media configuration display page. Media or audio contents that are included in the playlist and accessed/streamed from mobile media applications/sources/providers/APIs on the mobile device 102 can be configured and/or displayed by the vehicle session application 106 on the vehicle built-in image display 120. Some or all of the media or audio contents in the same playlist may be provided by a single media content application, source, provider, etc. Additionally, optionally or alternatively, some or all of the media or audio contents in the same playlist may be provided by multiple media content applications, sources, providers, etc.

The user may dynamically reconfigure the playlist while the playlist is being rendered as a part of a specific vehicle session in the vehicle. For example, the user may alter the composition of the media or audio contents in the “Winter Blizzard” or the current playing order while one of its component media contents or audio contents such as “Cenotaph” is being played in the specific vehicle session in the vehicle.

FIG. 3G illustrates an example graphic layout for non-media configuration display page. This display page may be accessed from the “Home Screen” display page, a vehicle session playing display page, or a different display page rendered on the vehicle built-in image display 120. By way of illustration but not limitation, non-media vehicle components may be configured for a specific vehicle session type “Cool”. The current settings for the non-media vehicle components of the “Cool” vehicle session type may be configured or displayed in this non-media configuration display page.

The user may dynamically reconfigure some or all of the non-media vehicle component while these non-media vehicle components are currently operating a part of a vehicle session of the in the “Cool” vehicle session type. For example, the user may alter settings relating to any, some or all of: temperature, air flow, air condition, seat heating, seat cooler, seat massage type, seat massage intensity, ambient color, ambient brightness, footwells, etc., for the currently rendered/played vehicle session of the “Cool” vehicle session type in the vehicle using this display page.

### 3.10. Additional GUI Examples

FIG. 3H illustrates an example graphic layout for viewing and selecting post-user-activity vehicle session types. This display page may be accessed from the “Home Screen” display page, a vehicle session playing display page, or a different display page rendered on the vehicle built-in image display 120. Additionally, optionally or alternatively, this display page may be used as a landing page following the user's physical activities. By way of illustration but not limitation, for each different user activity, a post-user-activity vehicle session type may be defined, specified, played or rendered in vehicle using media and non-media components or systems of the vehicle.

FIG. 3I illustrates an example graphic layout for configuring ambient light for one or more specific vehicle session types. This display page may be accessed from the “Home Screen” display page, a vehicle session playing display page, or a different display page rendered on the vehicle built-in image display 120. Additionally, optionally or alternatively, this display page may be accessed from a vehicle session media or non-media configuration display page. By way of illustration but not limitation, like other display pages, the user can view the current ambient light setting(s) on this display page rendered on the vehicle built-in image display 120 and select a specific setting such as color for ambient lights to be rendered in the one or more specific vehicle session types.

FIG. 3J illustrates an example graphic layout for configuring seat massage function (or seat massager). This display page may be accessed from the “Home Screen” display page, a vehicle session playing display page, or a different display page rendered on the vehicle built-in image display 120. Additionally, optionally or alternatively, this display page may be accessed from a vehicle session media or non-media configuration display page. By way of illustration but not limitation, like other display pages, the user can view the current seat massage settings on this display page rendered on the vehicle built-in image display 120 and select specific settings of specific seat(s), massage type(s), massage level(s), etc., of the seat massage function to be rendered or performed in the one or more specific vehicle session types.

FIG. 3K illustrates an example graphic layout for viewing and selecting pre-user-activity vehicle session types. This display page may be accessed from the “Home Screen” display page, a vehicle session playing display page, or a different display page rendered on the vehicle built-in image display 120. By way of illustration but not limitation, for each of some or all user activity to be engaged by the user (e.g., shortly, after this vehicle session, etc.), a pre-user-activity vehicle session type may be defined, specified, played or rendered in vehicle using media and non-media components or systems of the vehicle.

### 4.0. Example Process Flows

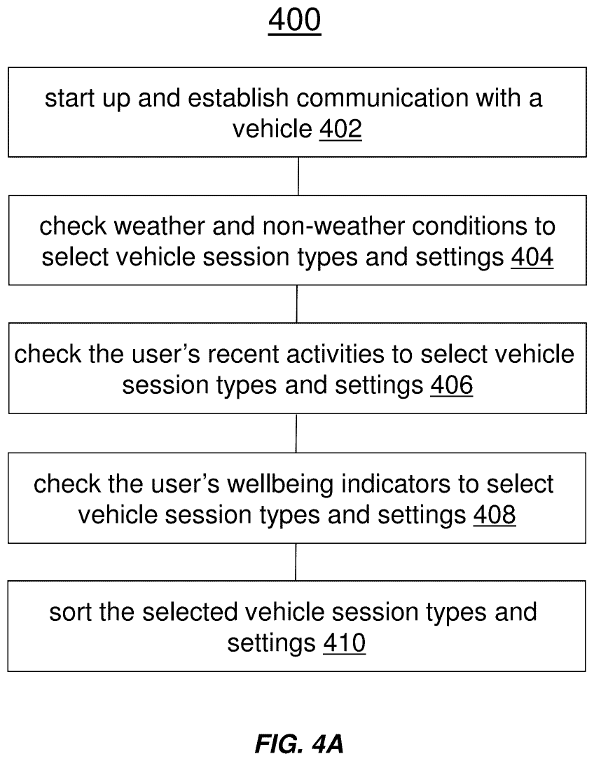

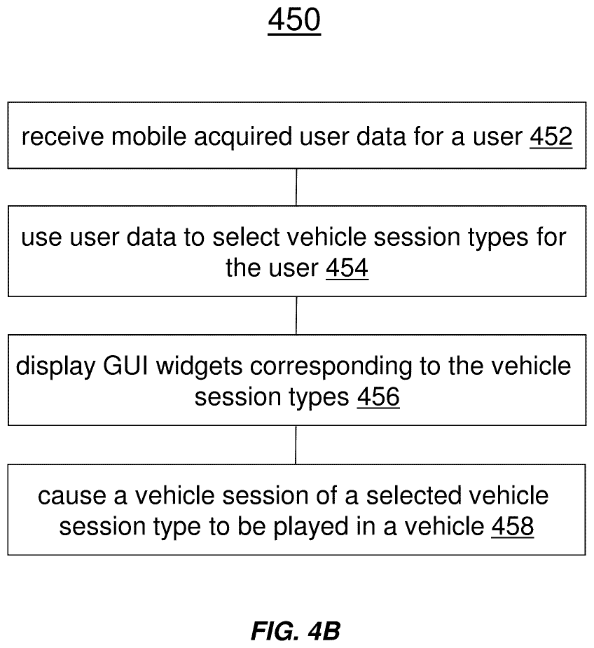

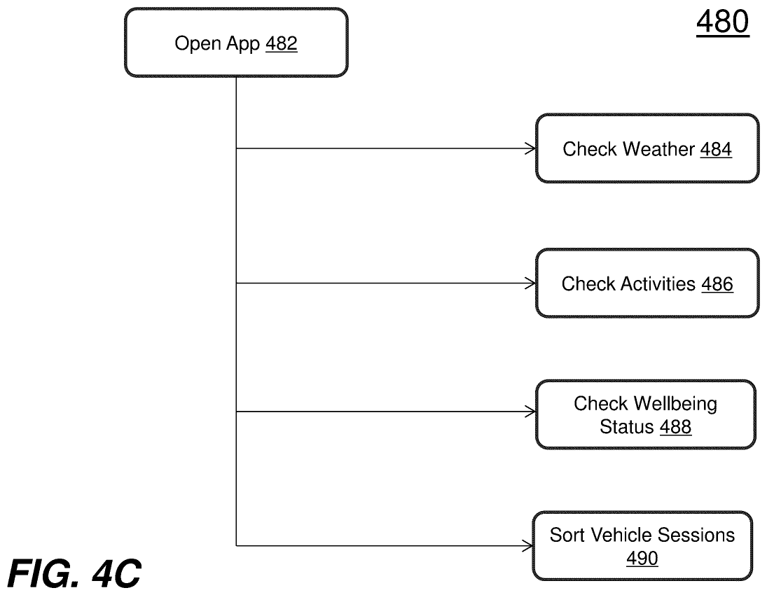

FIG. 4A illustrates an example process flow 400 according to an embodiment. In some embodiments, one or more computing devices or components may perform this process flow. In block 402, a vehicle session application (e.g., a mobile application on a mobile device, a computing application such as a vehicle session application on a handheld computing system or a wearable device or a computing device operating with a vehicle, etc.) as described herein starts up. For example, the gadget representing the application on a user interface on a mobile device is opened by a user of the mobile device and a vehicle. The vehicle application may establish connection with a head unit of the vehicle using wireless or wired data/network communication links between the mobile device and the vehicle.

In block 404, the vehicle session application checks (e.g., current, impending, etc.) weather at the location of the vehicle. For example, the current (outside) temperature may be measured or collected and compared with upper and lower thresholds. Based on the comparisons with the thresholds, some or all vehicle session types supported or configured by the vehicle session application may be recommended, for example by looking up a decision matrix or table, to the user, for example, on a “Home Screen” display page rendered on the mobile device or a vehicle built-in image display of the vehicle by way of the head unit of the vehicle.

In some operational scenarios, in a vehicle session of a user selected or recommended vehicle session type, (e.g., non-media, other than media systems used to render media contents, etc.) vehicle components may be configured, controlled or operated—e.g. cool down cabin, warm up cabin, seat heat on, window defrost on, etc.—based at least in part on the comparisons of the current temperatures with the thresholds. Other weather conditions or measurements such as air quality index (AQI), precipitation such as raining or snowing, heat wave presence or warming, dry air, humid air, UV index, wind, etc., may also be used to select recommended vehicle session types and/or control/operate vehicle components to perform specific operations/actions or to be set to specific operational states.

In some operational scenarios, the vehicle session application may implement or render GUI display pages to interact with the user to view or access some or all of these weather conditions or measurements on the GUI display pages or widgets/gadgets rendered therein.

In some operational scenarios, non-weather conditions relating to the user or the vehicle—e.g., user stuck in traffic, going home, going to work, going on a long trip, etc.—may also be checked by the vehicle session application and used in part or in whole to control or operate vehicle components of the vehicle and/or to recommend vehicle session types.

In block 406, the vehicle session application checks the user's recent activities related to health, exercise, resting, fitness, etc. Example activities may include, but are not necessarily limited to only, any of: archery, bowing, fencing, gymnastics, track and field, American football, Australian football, baseball, basketball, etc. Some or all of the user's recent activities may be used in part or in whole to control or operate vehicle components of the vehicle and/or to recommend vehicle session types, for example by looking up a decision matrix or table.

In block 408, the vehicle session application checks the user's wellbeing statuses or indicators, for example, generated by mobile health and/or fitness applications on the user's mobile device. Example wellbeing statuses or indicators may include, but are not necessarily limited to only, any of: sleep goal met, sleep goal not met, steps met, steps not met, stress level high, stress level low, recorded calories met goal, etc. Some or all of the user's wellbeing statuses or indicators may be used in part or in whole to control or operate vehicle components of the vehicle and/or to recommend vehicle session types, for example by looking up a decision matrix or table.

In block 410, the vehicle session application sorts or ranks the recommended vehicle session types and/or recommended actions/operations/settings of vehicle components generated based at least in part on some or all of the weather conditions, non-weather conditions, user's recent activities, the user's wellbeing statuses or indicators, etc. Some or all of these recommendations may be represented with widgets/gadgets rendered on GUI display pages as described herein. Each widget/gadget may be assigned with a respective usage score generated from usages or histories of usages of the widget/gadget and/or usage or selection histories of vehicle session types as determined or maintained by the vehicle session application. Special visual indications such as badges may be rendered with newly added or recommended vehicle session types or newly added or recommended actions/operations/settings of vehicle components. The most popular recommendations may be visually presented or represented as shortcuts, preconditions, defaults, etc., on one or more GUI display pages.

FIG. 4B illustrates an example process flow 450 according to an embodiment. In some embodiments, one or more computing devices or components may perform this process flow. In block 452, a mobile application on a mobile device receives mobile acquired user data on the mobile device. The mobile acquired user data is specific for a user of the mobile device and a vehicle that connects with the mobile device.

In block 454, based at least in part on the mobile acquired user data, the mobile application selects a set of vehicle session types for the user.

In block 456, the mobile application communicates with one or more vehicle built-in computing devices of the vehicle to cause a set of graphic user interface (GUI) widgets corresponding to the set of vehicle session types to be rendered on a vehicle built-in image display of the vehicle. Each GUI widget in the set of GUI widgets corresponds to a respective vehicle session type in the set of vehicle session types.

In block 458, in response to receiving an indication of a user selection of a specific GUI widget corresponding to a specific vehicle session type, the mobile application communicates with the one or more vehicle built-in computing devices to cause a vehicle session of the specific vehicle session type to be played in the vehicle. One or more non-media vehicle components of the vehicle performs operations based at least in part on specific vehicle session configuration data specified by the mobile application for the specific vehicle session type.

In an embodiment, the mobile acquired user data includes at least a portion acquired from one or more of: mobile health applications, mobile fitness applications, or mobile media applications, on the mobile device.

In an embodiment, the mobile acquired user data includes at least a portion acquired from an external computing device external to the mobile device through one or more application programming interfaces (APIs).

In an embodiment, the mobile acquired user data includes one or more of: weather conditions, traffic conditions, vehicle conditions, user recent activity data, user fitness indicators, histories of user selections of vehicle session types, etc.

In an embodiment, the set of vehicle session types represents a proper subset selected by the mobile application from among a plurality of different vehicle session types.

In an embodiment, the mobile device is connected with the vehicle through a head unit of the vehicle among the one or more vehicle built-in computing devices; the mobile application on the mobile device communicates with the head unit of the vehicle to cause the set of GUI widgets presented on the vehicle built-in image display and to cause the one or more non-media vehicle components specifically controlled for the vehicle session of the specific vehicle session type.

In an embodiment, the mobile acquired user data includes vehicle session configuration data and past vehicle session history data, as maintained for the user by the mobile application on the mobile device.

In an embodiment, the set of vehicle session types selected for the user includes a subset of vehicle session types selected based at least in part on mobile health data.

In an embodiment, the set of vehicle session types selected for the user includes a subset of vehicle session types selected based at least in part on past vehicle session history data.

In an embodiment, the set of vehicle session types selected for the user includes a subset of vehicle session types selected based at least in part on user data generated by a mobile media application installed on the mobile device.

In an embodiment, the one or more non-media vehicle components are free of audiovisual components; wherein the one or more non-media vehicle components represent one or more of: seats, windows, doors, lighting components, air conditioners, air ventilators, other non-media vehicle components other than audiovisual components, etc.

In an embodiment, the mobile application formulates and sends one or more web protocol based messages to the one or more vehicle built-in computing devices to control the one or more non-media vehicle components via one or more web service interfaces of a web server implemented with the one or more vehicle built-in computing devices of the vehicle.

In an embodiment, the one or more web service interfaces of the web server include one or more representational state transfer (REST) web service interfaces.

In an embodiment, the one or more non-media vehicle components include a vehicle component that is configured to be set to different operational states for different media content portions of a media program rendered along with the vehicle session.

In an embodiment, the media program includes a music piece being streamed by one of the one or more second mobile application; the vehicle component is set to the different operational states for different portions of the music piece rendered by a vehicle built-in audio system of the vehicle along with the vehicle session.

In an embodiment, the vehicle component represents a vehicle built-in temperature control; the vehicle built-in temperature control is set to different temperatures for the different media content portions rendered along with the vehicle session.

In an embodiment, the vehicle component represents a vehicle built-in lighting effect control; the vehicle built-in temperature control is set to different lighting effects for the different media content portions rendered along with the vehicle session.

In an embodiment, the user enters a second different vehicle; wherein the mobile device is connected with the second different vehicle by way of one or more second vehicle built-in computing devices of the second different vehicle; the second different vehicle is caused to play a second vehicle session of the same specific vehicle session type by controlling one or more second non-media vehicle components of the second different vehicle based at least in part on the same specific vehicle session configuration data specified for the same specific vehicle session type.

In an embodiment, the vehicle session application further performs: in response to receiving the indication of the user selection of the specific GUI widget corresponding to the specific vehicle session type, as a part of playing the vehicle session of the specific vehicle session type, controlling one or more media vehicle components of the vehicle based at least in part on the specific vehicle session configuration data specified for the specific vehicle session type to which the specific GUI widget corresponds.

FIG. 4C illustrates an example process flow 480 according to an embodiment. In some embodiments, one or more computing devices or components may perform this process flow.

In block 482, a vehicle session application (e.g., a mobile application on a mobile device, a computing application such as a vehicle session application on a handheld computing system or a wearable device or a computing device operating with a vehicle, etc.) as described herein is opened by a user. For example, the gadget representing the application on a user interface on a mobile device is opened by a user of the mobile device and a vehicle. The vehicle application may establish connection with a head unit of the vehicle using wireless or wired data/network communication links between the mobile device and the vehicle. The vehicle session application may execute some or all operations including but not necessarily limited to only those illustrated in blocks 484 through 490.

In block 484, the vehicle session application checks (e.g., current and/or pending, etc.) weather, for example based on weather data gathered through or by weather APIs and/or applications in the operational environment of the mobile device. Different candidate vehicle session types may be selected based at least in part on the weather data.

For example, in response to determining that the (e.g., current and/or pending, etc.) temperature is above 70 degrees Fahrenheit, the vehicle session app may identify or establish one or more vehicle session types with cool down cabin (conditions/settings) as candidate vehicle session types. Conversely, in response to determining that the (e.g., current and/or pending, etc.) temperature is below 40 degrees Fahrenheit, the vehicle session app may identify or establish one or more vehicle session types with warm up cabin, seat heat on, window defrost on, etc., (conditions/settings) as candidate vehicle session types.

In response to determining that the (e.g., current and/or pending, etc.) Air Quality Index or AQI is relatively high such as above 100, the vehicle session app may identify or establish one or more vehicle session types with recirculation air on (conditions/settings) as candidate vehicle session types.

In response to determining that it is raining, the vehicle session app may provide or render an umbrella reminder, for example, on a vehicle built-in image display operating with the head unit installed with the vehicle or the mobile device's image display.

In response to determining that it is snowing, the vehicle session app may identify or establish one or more vehicle session types with warm up cabin, seat heat on, window defrost on, etc., (conditions/settings) as candidate vehicle session types. In comparison, in response to determining that a heat wave is present, the vehicle session app may identify or establish one or more vehicle session types with cool down cabin (conditions/settings) as candidate vehicle session types.

Additionally, optionally or alternatively, the vehicle session app may also determine other non-weather related data and identify/determine/select candidate vehicle session types based at least in part on the non-weather related data. For example, in response to determining that the user is stuck in the traffic, the vehicle session app may identify or establish one or more vehicle session types with seat massage, immersive meditation, etc., (conditions/settings) as candidate vehicle session types.

In response to determining that the user is heading or going home, the vehicle session app may identify or establish one or more first vehicle session types with first set mood (conditions/settings/music selections) specifically recommended or selected for home going as candidate vehicle session types. In comparison, in response to determining that the user is going on a relatively long trip, the vehicle session app may identify or establish one or more second vehicle session types with second set mood (conditions/settings/music selections) specifically recommended or selected for long trips as candidate vehicle session types.

In block 486, the vehicle session application checks the user's (e.g., recent, current and/or pending, etc.) activities, for example based on user activity data gathered through or by activity data collection (e.g., from a wearable or smartwatch device, from the mobile phone on which the vehicle session application is running, etc.) APIs and/or applications in the operational environment of the mobile device. Some or all of the user activity data may be collected by wearable, smartwatch and/or mobile device(s) automatically and/or with manual user input. Different candidate vehicle session types may be selected based at least in part on the user activity data.

For example, in response to determining that the user's recent activity was archery, the vehicle session app may identify or establish one or more vehicle session types with seat massage (conditions/settings) as candidate vehicle session types. Additionally, optionally or alternatively, the vehicle session app may provide a (e.g., graphical, audible, visual, etc.) AQI indicator, for example, with a vehicle built-in image display operating with the head unit installed with the vehicle or the mobile device's image display.

In response to determining that the user's recent activity was bowling, the vehicle session app may identify or establish one or more vehicle session types with seat massage (conditions/settings) as candidate vehicle session types. Additionally, optionally or alternatively, the vehicle session app may identify or establish vehicle session type(s) with set mood (conditions/settings/music selections) specifically recommended or selected for bowling recent activities as candidate vehicle session types.

In response to determining that the user's recent activity was bowling, the vehicle session app may identify or establish one or more vehicle session types with seat massage (conditions/settings) as candidate vehicle session types. Additionally, optionally or alternatively, the vehicle session app may identify or establish vehicle session type(s) with set mood (conditions/settings/music selections) specifically recommended or selected for bowling recent activities as candidate vehicle session types.

In block 488, the vehicle session application checks the user's (e.g., recent, current and/or pending, etc.) wellbeing status, for example based on user health/wellbeing related data gathered through or by health/wellbeing related data collection (e.g., from a wearable or smartwatch device, from the mobile phone on which the vehicle session application is running, etc.) APIs and/or applications in the operational environment of the mobile device. Some or all of the user health/wellbeing related data may be collected by wearable, smartwatch and/or mobile device(s) automatically and/or with manual user input. Different candidate vehicle session types may be selected based at least in part on the user health/wellbeing related data.

For example, in response to determining that the user wellbeing status indicates that the user's sleep goal has not been met, the vehicle session app may select or start a vehicle session type with (e.g., relatively quiet, etc.) white noise ambient in the vehicle followed by a (e.g., relatively loud, etc.) wake call reminder.

In response to determining that the user wellbeing status indicates that the user's stress level is relatively high, the vehicle session app may identify or establish one or more vehicle session types with seat massage and immersive meditation (conditions/settings) as candidate vehicle session types. Additionally, optionally or alternatively, the vehicle session app may identify or establish vehicle session type(s) with set mood (conditions/settings/music selections) specifically recommended or selected for bowling recent activities as candidate vehicle session types.

In block 490, the vehicle session application sorts or orders candidate vehicle session types specifically selected or recommended based at least in part on some or all of the weather data, the user's activities, user's wellbeing status, etc.

Widgets or icons may be used to (e.g., visually, etc.) represent the candidate vehicle session types on the vehicle built-in image display of the vehicle or the mobile device's image display. Duplicate widgets or their corresponding candidate vehicle session types may be displayed or shown once. Some or all of these widgets or corresponding vehicle session types may be displayed in an order prioritized based on their respective frequencies of use (e.g., vehicle session history data, etc.). For candidate vehicle session types with conflicting conditions/settings. For example, in some operational scenarios, two different candidate vehicle session types with cool down and warm up conditions (or settings) may be identified or recommended; both candidate vehicle session types may be displayed to the user for (e.g., final, further, etc.) selection.

In some operational scenarios, every widget or a corresponding vehicle session type thereby may be assigned with a usage score (or priority) starting or initialized at zero (0). Each time the widget or vehicle session type is selected, the usage score is incremented by one (1). Each time the widget or vehicle session type is dismissed or terminated (e.g., prematurely, less than 90% of the entire duration played, etc.), the usage score is decremented by one (1).

Additionally, optionally or alternatively, in some operational scenarios, each week such as every Monday, a respective usage score (or priority) for every widget or its corresponding vehicle session type may be added with a specific negative value such as −7. Any resultant positive usage score (or priority) may accord its corresponding widget or vehicle session type a relatively high priority if the widget or vehicle session type has been selected or used more than 7 times. In comparison, any resultant negative usage score (or priority) for a widget or vehicle session type may be set or reset to zero (0), and hence be given a correspondingly lower priority than the more frequently used or selected widgets or vehicle session types.

In some operational scenarios, newly created vehicle session types may be visually indicated in an image display as described herein, for example with specifically selected badge(s).

In an embodiment, a computing device is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Other examples of these and other embodiments are found throughout this disclosure. Note that, although separate embodiments are discussed herein, any combination of embodiments and/or partial embodiments discussed herein may be combined to form further embodiments.

### 5.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

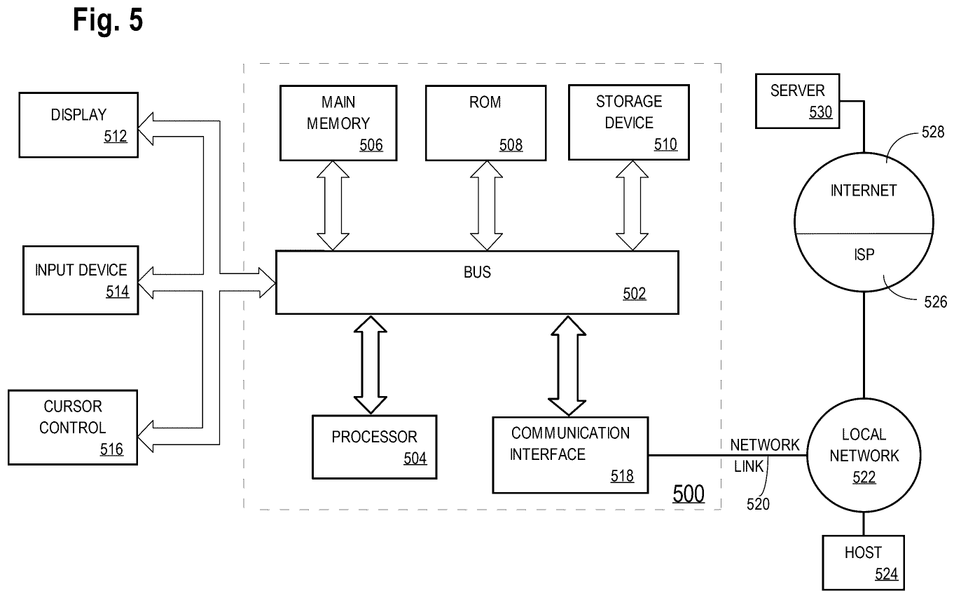

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 505, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as a 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

The invention claimed is:

1. A method comprising:
receiving, by a mobile application on a mobile device, mobile acquired user data on the mobile device, wherein the mobile acquired user data is specific for a user of the mobile device and a vehicle that connects with the mobile device;
based at least in part on the mobile acquired user data, selecting, by the mobile application, a set of vehicle session types for the user;
communicating, by the mobile application, with one or more vehicle built-in computing devices of the vehicle to cause a set of graphic user interface (GUI) widgets corresponding to the set of vehicle session types to be rendered on an image display, wherein each GUI widget in the set of GUI widgets corresponds to a respective vehicle session type in the set of vehicle session types;
in response to receiving an indication of a user selection of a specific GUI widget corresponding to a specific vehicle session type, communicating, by the mobile application, with the one or more vehicle built-in computing devices to cause a vehicle session of the specific vehicle session type to be played in the vehicle, wherein one or more non-media vehicle components of the vehicle performs operations based at least in part on specific vehicle session configuration data specified by the mobile application for the specific vehicle session type.

2. The method of claim 1, wherein the mobile acquired user data includes at least a portion acquired from one or more of: mobile health applications, mobile fitness applications, or mobile media applications, on the mobile device.

3. The method of claim 1, wherein the mobile acquired user data includes at least a portion acquired from an external computing device external to the mobile device through one or more application programming interfaces (APIs).

4. The method of claim 1, wherein the mobile acquired user data includes one or more of: weather conditions, traffic conditions, vehicle conditions, user recent activity data, user fitness indicators, or histories of user selections of vehicle session types.

5. The method of claim 1, wherein the set of vehicle session types represents a proper subset selected by the mobile application from among a plurality of different vehicle session types.

6. The method of claim 1, wherein the mobile device is connected with the vehicle through a head unit of the vehicle among the one or more vehicle built-in computing devices; wherein the mobile application on the mobile device communicates with the head unit of the vehicle to cause the set of GUI widgets presented on a vehicle built-in image display and to cause the one or more non-media vehicle components specifically controlled for the vehicle session of the specific vehicle session type.

7. The method of claim 1, wherein the mobile acquired user data includes vehicle session configuration data and past vehicle session history data, as maintained for the user by the mobile application on the mobile device.

8. The method of claim 1, wherein the user enters a second different vehicle; wherein the mobile device is connected with the second different vehicle by way of one or more second vehicle built-in computing devices of the second different vehicle; wherein the second different vehicle is caused to play a second vehicle session of the same specific vehicle session type by controlling one or more second non-media vehicle components of the second different vehicle based at least in part on the same specific vehicle session configuration data specified for the same specific vehicle session type.

9. One or more non-transitory computer readable media storing a program of instructions that is executable by a device to perform:
receiving, by a mobile application on a mobile device, mobile acquired user data on the mobile device, wherein the mobile acquired user data is specific for a user of the mobile device and a vehicle that connects with the mobile device;
based at least in part on the mobile acquired user data, selecting, by the mobile application, a set of vehicle session types for the user;
communicating, by the mobile application, with one or more vehicle built-in computing devices of the vehicle to cause a set of graphic user interface (GUI) widgets corresponding to the set of vehicle session types to be rendered on an image display, wherein each GUI widget in the set of GUI widgets corresponds to a respective vehicle session type in the set of vehicle session types;
in response to receiving an indication of a user selection of a specific GUI widget corresponding to a specific vehicle session type, communicating, by the mobile application, with the one or more vehicle built-in computing devices to cause a vehicle session of the specific vehicle session type to be played in the vehicle, wherein one or more non-media vehicle components of the vehicle performs operations based at least in part on specific vehicle session configuration data specified by the mobile application for the specific vehicle session type.

10. The media of claim 9, wherein the mobile acquired user data includes at least a portion acquired from one or more of: mobile health applications, mobile fitness applications, or mobile media applications, on the mobile device.

11. The media of claim 9, wherein the mobile acquired user data includes at least a portion acquired from an external computing device external to the mobile device through one or more application programming interfaces (APIs).

12. The media of claim 9, wherein the mobile acquired user data includes one or more of: weather conditions, traffic conditions, vehicle conditions, user recent activity data, user fitness indicators, or histories of user selections of vehicle session types.

13. The media of claim 9, wherein the set of vehicle session types represents a proper subset selected by the mobile application from among a plurality of different vehicle session types.

14. The media of claim 9, wherein the mobile device is connected with the vehicle through a head unit of the vehicle among the one or more vehicle built-in computing devices; wherein the mobile application on the mobile device communicates with the head unit of the vehicle to cause the set of GUI widgets presented on a vehicle built-in image display and to cause the one or more non-media vehicle components specifically controlled for the vehicle session of the specific vehicle session type.

15. The media of claim 9, wherein the mobile acquired user data includes vehicle session configuration data and past vehicle session history data, as maintained for the user by the mobile application on the mobile device.

16. The media of claim 9, wherein the user enters a second different vehicle; wherein the mobile device is connected with the second different vehicle by way of one or more second vehicle built-in computing devices of the second different vehicle; wherein the second different vehicle is caused to play a second vehicle session of the same specific vehicle session type by controlling one or more second non-media vehicle components of the second different vehicle based at least in part on the same specific vehicle session configuration data specified for the same specific vehicle session type.

17. A system comprising: one or more computing processors; one or more non-transitory computer readable media storing a program of instructions that is executable by the one or more computing processors to perform:
receiving, by a mobile application on a mobile device, mobile acquired user data on the mobile device, wherein the mobile acquired user data is specific for a user of the mobile device and a vehicle that connects with the mobile device;
based at least in part on the mobile acquired user data, selecting, by the mobile application, a set of vehicle session types for the user;
communicating, by the mobile application, with one or more vehicle built-in computing devices of the vehicle to cause a set of graphic user interface (GUI) widgets corresponding to the set of vehicle session types to be rendered on an image display, wherein each GUI widget in the set of GUI widgets corresponds to a respective vehicle session type in the set of vehicle session types;
in response to receiving an indication of a user selection of a specific GUI widget corresponding to a specific vehicle session type, communicating, by the mobile application, with the one or more vehicle built-in computing devices to cause a vehicle session of the specific vehicle session type to be played in the vehicle, wherein one or more non-media vehicle components of the vehicle performs operations based at least in part on specific vehicle session configuration data specified by the mobile application for the specific vehicle session type.

18. The system of claim 17, wherein the mobile acquired user data includes at least a portion acquired from one or more of: mobile health applications, mobile fitness applications, or mobile media applications, on the mobile device.

19. The system of claim 17, wherein the mobile acquired user data includes at least a portion acquired from an external computing device external to the mobile device through one or more application programming interfaces (APIs).

20. The system of claim 17, wherein the mobile acquired user data includes one or more of: weather conditions, traffic conditions, vehicle conditions, user recent activity data, user fitness indicators, or histories of user selections of vehicle session types.

21. The system of claim 17, wherein the set of vehicle session types represents a proper subset selected by the mobile application from among a plurality of different vehicle session types.

22. The system of claim 17, wherein the mobile device is connected with the vehicle through a head unit of the vehicle among the one or more vehicle built-in computing devices; wherein the mobile application on the mobile device communicates with the head unit of the vehicle to cause the set of GUI widgets presented on a vehicle built-in image display and to cause the one or more non-media vehicle components specifically controlled for the vehicle session of the specific vehicle session type.

23. The system of claim 17, wherein the mobile acquired user data includes vehicle session configuration data and past vehicle session history data, as maintained for the user by the mobile application on the mobile device.

24. The system of claim 17, wherein the user enters a second different vehicle; wherein the mobile device is connected with the second different vehicle by way of one or more second vehicle built-in computing devices of the second different vehicle; wherein the second different vehicle is caused to play a second vehicle session of the same specific vehicle session type by controlling one or more second non-media vehicle components of the second different vehicle based at least in part on the same specific vehicle session configuration data specified for the same specific vehicle session type.
